(19) United States
(12) Patent Application Publication
(10) Pub. No.: US 2023/0179797 A1
(43) Pub. Date: Jun. 8, 2023

(54) IMAGE PROCESSING APPARATUS AND METHOD

(71) Applicant: SONY GROUP CORPORATION, Tokyo (JP)

(72) Inventors: Kao HAYASHI, Kanagawa (JP); Ohji NAKAGAMI, Tokyo (JP); Satoru KUMA, Tokyo (JP); Koji YANO, Tokyo (JP); Tsuyoshi KATO, Kanagawa (JP); Hiroyuki YASUDA, Saitama (JP)

(73) Assignee: SONY GROUP CORPORATION, Tokyo (JP)

(21) Appl. No.: 17/910,679

(22) PCT Filed: Mar. 11, 2021
(86) PCT No.: PCT/JP2021/009735

§ 371 Date: Sep. 9, 2022

(30) Foreign Application Priority Data
Mar. 25, 2020 (JP) 2020-053703

(51) Int. Cl. H04N 19/597; G06T 17/00; G06T 5/00; H04N 13/351; H04N 19/172

(52) U.S. Cl. CPC H04N 19/597; G06T 17/00; G06T 5/002; H04N 13/351; H04N 19/172

(57) ABSTRACT

There is provided an image processing apparatus and method, electronic device, and program enabling suppression of deterioration of image quality. A base video frame is generated in which a base patch is arranged, the base patch being obtained by projecting, on a two-dimensional plane for each partial region, a point cloud representing an object having a three-dimensional shape as a set of points, and an additional video frame is generated in which an additional patch is arranged, the additional patch being obtained by projecting, on the two-dimensional plane same as in a case of the base patch, a partial region including at least a part of the partial region corresponding to the base patch of the point cloud, with at least some of parameters made different from a case of the base patch. By encoding the generated base video frame and additional video frame, coded data is generated.

### TECHNICAL FIELD

The present disclosure relates to an image processing apparatus and method, and more particularly, to an image processing apparatus and method capable of suppressing deterioration of image quality.

### BACKGROUND ART

Conventionally, encoding and decoding of point cloud data representing an object having a three-dimensional shape as a set of points has been standardized by a moving picture experts group (MPEG) (see, for example, Non Patent Document 1).

Furthermore, there has been proposed a method (hereinafter, also referred to as a video-based approach) of projecting geometry data and attribute data of a point cloud onto a two-dimensional plane for every small region, arranging an image (a patch) projected on the two-dimensional plane in a frame image, and encoding the frame image by an encoding method for a two-dimensional image (see, for example, Non Patent Document 2 to Non Patent Document 4).

### CITATION LIST

### Non Patent Document

Non Patent Document 1: “Information technology—MPEG-I (Coded Representation of Immersive Media)—Part 9: Geometry-based Point Cloud Compression”, ISO/IEC 23090-9:2019(E)
Non Patent Document 2: Tim Golla and Reinhard Klein, “Real-time Point Cloud Compression,” IEEE, 2015
Non Patent Document 3: K. Mammou, “Video-based and Hierarchical Approaches Point Cloud Compression”, MPEG m41649, Oct. 2017
Non Patent Document 4: K. Mammou, “PCC Test Model Category 2 v0” N17248 MPEG output document, October 2017

### SUMMARY OF THE INVENTION

### Problems to be Solved by the Invention

However, in the case of the video-based approach described in Non Patent Document 2 to Non Patent Document 4, accuracy of information has been uniformly set for all patches. That is, the accuracy of information cannot be locally changed. Therefore, there has been a possibility that quality of a point cloud in the same information amount is deteriorated as compared with a case where accuracy of information can be locally changed. Therefore, there has been a possibility that subjective image quality of a display image, in which a point cloud reconstructed by decoding coded data generated by the video-based approach is projected on the two-dimensional plane, is deteriorated.

The present disclosure has been made in view of such a situation, and an object thereof is to suppress a deterioration of image quality of a two-dimensional image for display of 3D data.

### Solutions to Problems

An image processing apparatus according to one aspect of the present technology is an image processing apparatus including: a video frame generation unit configured to generate a base video frame in which a base patch is arranged, the base patch being obtained by projecting, on a two-dimensional plane for each partial region, a point cloud representing an object having a three-dimensional shape as a set of points, and generate an additional video frame in which an additional patch is arranged, the additional patch being obtained by projecting, on the two-dimensional plane same as in a case of the base patch, a partial region including at least a part of the partial region corresponding to the base patch of the point cloud, with at least some of parameters made different from a case of the base patch; and an encoding unit configured to encode the base video frame and the additional video frame generated by the video frame generation unit, to generate coded data.

An image processing method according to one aspect of the present technology is an image processing method including: generating a base video frame in which a base patch is arranged, the base patch being obtained by projecting, on a two-dimensional plane for each partial region, a point cloud representing an object having a three-dimensional shape as a set of points, and generating an additional video frame in which an additional patch is arranged, the additional patch being obtained by projecting, on the two-dimensional plane same as in a case of the base patch, a partial region including at least a part of the partial region corresponding to the base patch of the point cloud, with at least some of parameters made different from a case of the base patch; and encoding the base video frame and the additional video frame that have been generated, to generate coded data.

An image processing apparatus according to another aspect of the present technology is an image processing apparatus including: a decoding unit configured to decode coded data, generate a base video frame in which a base patch is arranged, the base patch being obtained by projecting, on a two-dimensional plane for each partial region, a point cloud representing an object having a three-dimensional shape as a set of points, and generate an additional video frame in which an additional patch is arranged, the additional patch being obtained by projecting, on the two-dimensional plane same as in a case of the base patch, a partial region including at least a part of the partial region corresponding to the base patch of the point cloud, with at least some of parameters made different from a case of the base patch; and a reconstruction unit configured to reconstruct the point cloud by using the base video frame and the additional video frame generated by the decoding unit.

An image processing method according to another aspect of the present technology is an image processing method including: decoding coded data; generating a base video frame in which a base patch is arranged, the base patch being obtained by projecting, on a two-dimensional plane for each partial region, a point cloud representing an object having a three-dimensional shape as a set of points, and generating an additional video frame in which an additional patch is arranged, the additional patch being obtained by projecting, on the two-dimensional plane same as in a case of the base patch, a partial region including at least a part of the partial region corresponding to the base patch of the point cloud, with at least some of parameters made different from a case of the base patch; and reconstructing the point cloud by using the base video frame and the additional video frame that have been generated.

An image processing apparatus according to still another aspect of the present technology is an image processing apparatus including: an auxiliary patch information generation unit configured to generate auxiliary patch information that is information regarding a patch obtained by projecting a point cloud representing an object having a three-dimensional shape as a set of points on a two-dimensional plane for each partial region, the auxiliary patch information including an additional patch flag indicating whether an additional patch is not essential for reconstruction of a corresponding partial region of the point cloud; and an auxiliary patch information encoding unit configured to encode the auxiliary patch information generated by the auxiliary patch information generation unit, to generate coded data.

An image processing method according to still another aspect of the present technology is an image processing method including: generating auxiliary patch information that is information regarding a patch obtained by projecting a point cloud representing an object having a three-dimensional shape as a set of points on a two-dimensional plane for each partial region, the auxiliary patch information including an additional patch flag indicating whether an additional patch is not essential for reconstruction of a corresponding partial region of the point cloud; and encoding the generated auxiliary patch information, to generate coded data.

An image processing apparatus according to still another aspect of the present technology is an image processing apparatus including: an auxiliary patch information decoding unit configured to decode coded data, and generate auxiliary patch information that is information regarding a patch obtained by projecting a point cloud representing an object having a three-dimensional shape as a set of points on a two-dimensional plane for each partial region; and a reconstruction unit configured to reconstruct the point cloud by using the additional patch, on the basis of an additional patch flag that is included in the auxiliary patch information generated by the auxiliary patch information decoding unit and indicates whether an additional patch is not essential for reconstruction of a corresponding partial region of the point cloud.

An image processing method according to still another aspect of the present technology is an image processing method including: decoding coded data; generating auxiliary patch information that is information regarding a patch obtained by projecting a point cloud representing an object having a three-dimensional shape as a set of points on a two-dimensional plane for each partial region; and reconstructing the point cloud by using the additional patch, on the basis of an additional patch flag that is included in the generated auxiliary patch information and indicates whether an additional patch is not essential for reconstruction of a corresponding partial region of the point cloud.

In the image processing apparatus and method according to one aspect of the present technology, a base video frame is generated in which a base patch is arranged, the base patch being obtained by projecting, on a two-dimensional plane for each partial region, a point cloud representing an object having a three-dimensional shape as a set of points, and an additional video frame is generated in which an additional patch is arranged, the additional patch being obtained by projecting, on the two-dimensional plane same as in a case of the base patch, a partial region including at least a part of the partial region corresponding to the base patch of the point cloud, with at least some of parameters made different from a case of the base patch, and coded data is generated by encoding the generated base video frame and additional video frame.

In the image processing apparatus and method according to another aspect of the present technology, coded data is decoded, a base video frame is generated in which a base patch is arranged, the base patch being obtained by projecting, on a two-dimensional plane for each partial region, a point cloud representing an object having a three-dimensional shape as a set of points, and an additional video frame is generated in which an additional patch is arranged, the additional patch being obtained by projecting, on the two-dimensional plane same as in a case of the base patch, a partial region including at least a part of the partial region corresponding to the base patch of the point cloud, with at least some of parameters made different from a case of the base patch, and the point cloud is reconstructed by using the generated base video frame and additional video frame.

In the image processing apparatus and method according to still another aspect of the present technology, auxiliary patch information is generated, the auxiliary patch information being information regarding a patch obtained by projecting a point cloud representing an object having a three-dimensional shape as a set of points on a two-dimensional plane for each partial region, the auxiliary patch information including an additional patch flag indicating whether an additional patch is not essential for reconstruction of a corresponding partial region of the point cloud, and coded data is generated by encoding the generated auxiliary patch information.

In the image processing apparatus and method according to still another aspect of the present technology, coded data is decoded; auxiliary patch information is generated, the auxiliary patch information being information regarding a patch obtained by projecting a point cloud representing an object having a three-dimensional shape as a set of points on a two-dimensional plane for each partial region, and the point cloud is reconstructed by using the additional patch on the basis of an additional patch flag that is included in the generated auxiliary patch information and indicates whether an additional patch is not essential for reconstruction of a corresponding partial region of the point cloud.

### BRIEF DESCRIPTION OF DRAWINGS

FIG. 1 is a view for explaining data of a video-based approach.

FIG. 2 is a view for explaining transmission of an additional patch.

FIG. 3 is a view for explaining an additional patch.

FIG. 4 is a view for explaining an action target and an action manner of each method.

FIG. 5 is a view for explaining generation of an additional patch.

FIG. 6 is a view for explaining an action example of an additional patch.

FIG. 7 is a view for explaining an action example of an additional patch.

FIG. 8 is a view illustrating a configuration example of a patch.

FIG. 9 is a block diagram illustrating a main configuration example of an encoding device.

FIG. 10 is a block diagram illustrating a main configuration example of a packing encoding unit.

FIG. 11 is a flowchart for explaining an example of a flow of an encoding process.

FIG. 12 is a flowchart for explaining an example of a flow of a packing encoding process.

FIG. 13 is a block diagram illustrating a main configuration example of a decoding device.

FIG. 14 is a block diagram illustrating a main configuration example of a 3D reconstruction unit.

FIG. 15 is a flowchart for explaining an example of a flow of a decoding process.

FIG. 16 is a flowchart for explaining an example of a flow of the 3D reconstruction process.

FIG. 17 is a view for explaining generation of an additional patch.

FIG. 18 is a block diagram illustrating a main configuration example of the packing encoding unit.

FIG. 19 is a flowchart for explaining an example of a flow of the packing encoding process.

FIG. 20 is a block diagram illustrating a main configuration example of the 3D reconstruction unit.

FIG. 21 is a flowchart for explaining an example of a flow of the 3D reconstruction process.

FIG. 22 is a flowchart for explaining an example of a flow of the packing encoding process.

FIG. 23 is a flowchart for explaining an example of a flow of the 3D reconstruction process.

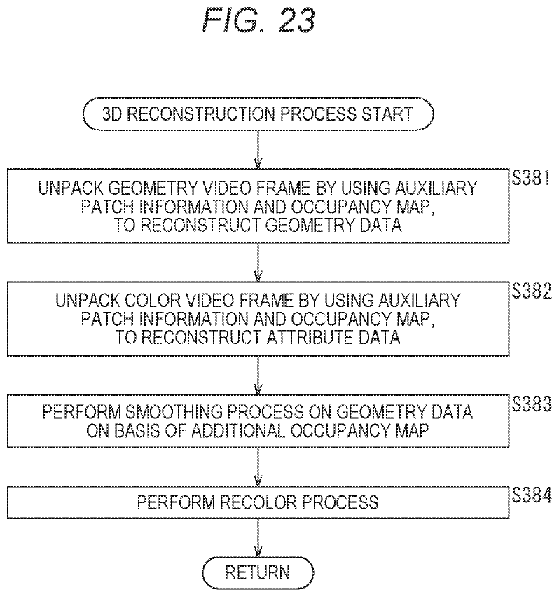

FIG. 24 is a block diagram illustrating a main configuration example of the packing encoding unit.

FIG. 25 is a flowchart for explaining an example of a flow of the packing encoding process.

FIG. 26 is a block diagram illustrating a main configuration example of the 3D reconstruction unit.

FIG. 27 is a flowchart for explaining an example of a flow of the 3D reconstruction process.

FIG. 28 is a view for explaining a configuration of auxiliary patch information.

FIG. 29 is a view for explaining information indicating an action target of an additional patch.

FIG. 30 is a view for explaining information indicating processing contents using an additional patch.

FIG. 31 is a view for explaining information regarding alignment of an additional patch.

FIG. 32 is a view for explaining size setting information of an additional occupancy map.

FIG. 33 is a view for explaining transmission information of each method.

FIG. 34 is a block diagram illustrating a main configuration example of a computer.

### MODE FOR CARRYING OUT THE INVENTION

Hereinafter, embodiments for implementing the present disclosure (hereinafter, referred to as embodiments) will be described. Note that the description will be given in the following order.

1. Transmission of additional patch

2. First embodiment (Method 1)

3. Second embodiment (Method 2)

4. Third embodiment (Method 3)

5. Fourth embodiment (Method 4)

6. Fifth embodiment (Method 5)

7. Supplementary note

### 1. Transmission of Additional Patch

<Documents and the Like that Support Technical Contents and Technical Terms>

The scope disclosed in the present technology includes, in addition to the contents described in the embodiments, contents described in the following Non Patent Documents and the like known at the time of filing, contents of other documents referred to in the following Non Patent Documents, and the like.
Non Patent Document 1: (described above)
Non Patent Document 2: (described above)
Non Patent Document 3: (described above)
Non Patent Document 4: (described above)

That is, the contents described in the above-described Non Patent Documents, the contents of other documents referred to in the above-described Non Patent Documents, and the like are also basis for determining the support requirement.

<Point Cloud>

Conventionally, there has been 3D data such as a point cloud representing a three-dimensional structure with point position information, attribute information, and the like.

For example, in a case of a point cloud, a three-dimensional structure (an object having a three-dimensional shape) is expressed as a set of a large number of points. Data of the point cloud (also referred to as point cloud data) includes position information (also referred to as geometry data) and attribute information (also referred to as attribute data) of each point. The attribute data can include any information. For example, color information, reflectance information, normal line information, and the like of each point may be included in the attribute data. As described above, the point cloud data has a relatively simple data structure, and can express any three-dimensional structure with sufficient accuracy by using a sufficiently large number of points.

<Quantization of Position Information with Use of Voxel>

Since such point cloud data has a relatively large data amount, an encoding method using a voxel has been conceived in order to compress the data amount by encoding or the like. The voxel is a three-dimensional region for quantizing geometry data (position information).

That is, a three-dimensional region (also referred to as a bounding box) containing a point cloud is divided into small three-dimensional regions called voxels, and whether or not a point is contained is indicated for each voxel. By doing in this way, a position of each point is quantized on a voxel basis. Therefore, by converting point cloud data into such data of voxels (also referred to as voxel data), an increase in information amount can be suppressed (typically, an information amount can be reduced).

<Overview of Video-Based Approach>

In a video-based approach, geometry data and attribute data of such a point cloud are projected on a two-dimensional plane for every small region (connection component). An image in which the geometry data and the attribute data are projected on the two-dimensional plane is also referred to as a projection image. Furthermore, the projection image for every small region is referred to as a patch. For example, in a projection image (a patch) of the geometry data, position information of a point is expressed as position information (a depth value (Depth)) in a direction (a depth direction) perpendicular to a projection plane.

Then, each patch generated in this way is arranged in the frame image. The frame image in which the patch of geometry data is arranged is also referred to as a geometry video frame. Furthermore, the frame image in which the patch of the attribute data is arranged is also referred to as a color video frame. For example, each pixel value of the geometry video frame indicates the depth value described above.

Then, these video frames are encoded by an encoding method for a two-dimensional image, such as, for example, advanced video coding (AVC) or high efficiency video coding (HEVC). That is, point cloud data that is 3D data representing a three-dimensional structure can be encoded using a codec for a two-dimensional image.

<Occupancy Map>

Note that, in a case of such a video-based approach, an occupancy map can also be used. The occupancy map is map information indicating the presence or absence of a projection image (a patch) for every N×N pixels of the geometry video frame. For example, the occupancy map indicates, by a value “1”, a region (N×N pixels) in which a patch is present in the geometry video frame or the color video frame, and indicates, by a value “0”, a region (N×N pixels) in which no patch is present.

Such an occupancy map is encoded as data separate from the geometry video frame and the color video frame, and transmitted to a decoding side. A decoder can grasp whether or not a patch is present in a region by referring to this occupancy map, so that an influence of noise or the like caused by encoding and decoding can be suppressed, and 3D data can be restored more precisely. For example, even if the depth value is changed by encoding and decoding, the decoder can ignore a depth value of a region where no patch is present (not process the depth value as position information of the 3D data), by referring to the occupancy map.

Note that, similarly to the geometry video frame, the color video frame, and the like, the occupancy map can also be transmitted as a video frame.

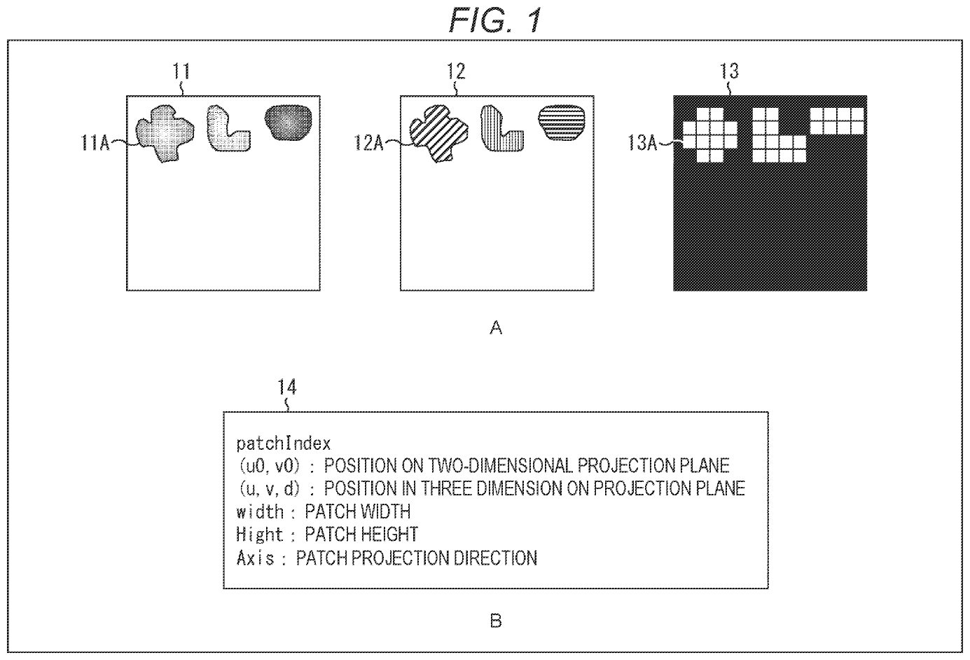

That is, in the case of the video-based approach, as illustrated in A, a geometry video frame 11 in which a patch 11A of geometry data of FIG. 1 is arranged, a color video frame 12 in which a patch 12A of attribute data is arranged, and an occupancy map 13 in which a patch 13A of the occupancy map is arranged are transmitted.

<Auxiliary Patch Information>

Moreover, in the case of the video-based approach, information regarding a patch (also referred to as auxiliary patch information) is transmitted as metadata. Auxiliary patch information 14 illustrated in B of FIG. 1 indicates an example of this auxiliary patch information. The auxiliary patch information 14 includes information regarding each patch. For example, as illustrated in B of FIG. 1, information such as patch identification information (patchIndex), a patch position (u0, v0) on a 2D projection plane (a two-dimensional plane onto which connection components (small regions) of a point cloud are projected), a position (u, v, d) of the projection plane in a three-dimensional space, a width of the patch (width), a height of the patch (Height), and a projection direction of the patch (Axis) is included.

<Moving Image>

Note that, in the following, it is assumed that (an object of) the point cloud may change in a time direction similarly to a moving image of a two-dimensional image. That is, the geometry data and the attribute data are assumed to be data having a concept of a time direction and sampled at predetermined time intervals, similarly to a moving image of a two-dimensional image. Note that, similarly to a video frame of a two-dimensional image, data at each sampling time is referred to as a frame. That is, point cloud data (geometry data and attribute data) is configured by a plurality of frames, similarly to a moving image of a two-dimensional image.

<Deterioration of Quality by Video-Based Approach>

However, in a case of this video-based approach, there has been a possibility that a loss of points occurs due to projection of a point cloud (a small region), a smoothing process, or the like. For example, when a projection direction becomes an unfavorable angle with respect to a small region three-dimensional shape, a loss of points may occur due to the projection. Furthermore, a loss of points may occur due to a change in shape of a patch by the smoothing process or the like. Therefore, there has been a possibility that subjective image quality of a display image, in which 3D data reconstructed by decoding coded data generated by the video-based approach is projected on the two-dimensional plane, is deteriorated.

However, in the case of the video-based approach described in Non Patent Document 2 to Non Patent Document 4, accuracy of information has been uniformly set for all patches. Therefore, for example, in order to improve accuracy of some of the patches, it is necessary to improve the accuracy of the entire patch of all the patches, and there has been a possibility that an information amount is unnecessarily increased and the encoding efficiency is reduced.

In other words, since the accuracy of the information cannot be locally changed, there has been a possibility that quality of a point cloud in the same information amount is deteriorated as compared with a case where the accuracy of the information can be locally changed. Therefore, there has been a possibility that subjective image quality of a display image, in which a point cloud reconstructed by decoding coded data generated by such a video-based approach is projected on the two-dimensional plane, is deteriorated.

For example, if the accuracy of the occupancy map is low, there has been a possibility that burrs occur at boundaries of the patches, and quality of the reconstructed point cloud is deteriorated. It is conceivable to improve the accuracy in order to suppress the occurrence of the burrs. However, in that case, it is difficult to locally control the accuracy, and thus it has been necessary to improve the accuracy of the entire occupancy map. Therefore, there has been a possibility that the information amount is unnecessarily increased, and the encoding efficiency is deteriorated.

Note that, as a method of reducing such burrs, that is, a method of suppressing deterioration of quality of a reconstructed point cloud, it has been considered to perform a smoothing process on geometry data. However, this smoothing process has a large processing amount, and there has been a possibility that a load is increased. Furthermore, a search for a place where the smoothing process is to be performed also has a large processing amount, and there has been a possibility that a load is increased.

Furthermore, since it is difficult to locally control the accuracy of information, for example, it has been necessary to reconstruct a distant object and a near object with respect to a viewpoint position with the same accuracy (resolution). For example, in a case where accuracy (resolution) of a distant object is adjusted to accuracy (resolution) of a near object, there has been a possibility that an information amount of the distant object is unnecessarily increased. On the other hand, in a case where accuracy (resolution) of a near object is adjusted to accuracy (resolution) of a distant object, there has been a possibility that quality of the near object is deteriorated, and subjective image quality of a display image is deteriorated.

Moreover, for example, it has been difficult to locally control quality of a point cloud reconstructed on the basis of authority of a user or the like (often locally control the subjective image quality of a display image). For example, it has been difficult to perform control such that the entire point cloud is provided with original quality (high resolution) to a user who has paid a high usage fee or a user having administrator authority, while the point cloud is provided with a part having a low quality (low resolution) (that is, provided in such a state in which a mosaic process is applied to a partial region in a two-dimensional image) to a user who has paid a low usage fee or a user who has guest authority. Therefore, it has been difficult to realize various services.

<Transmission of Additional Patch>

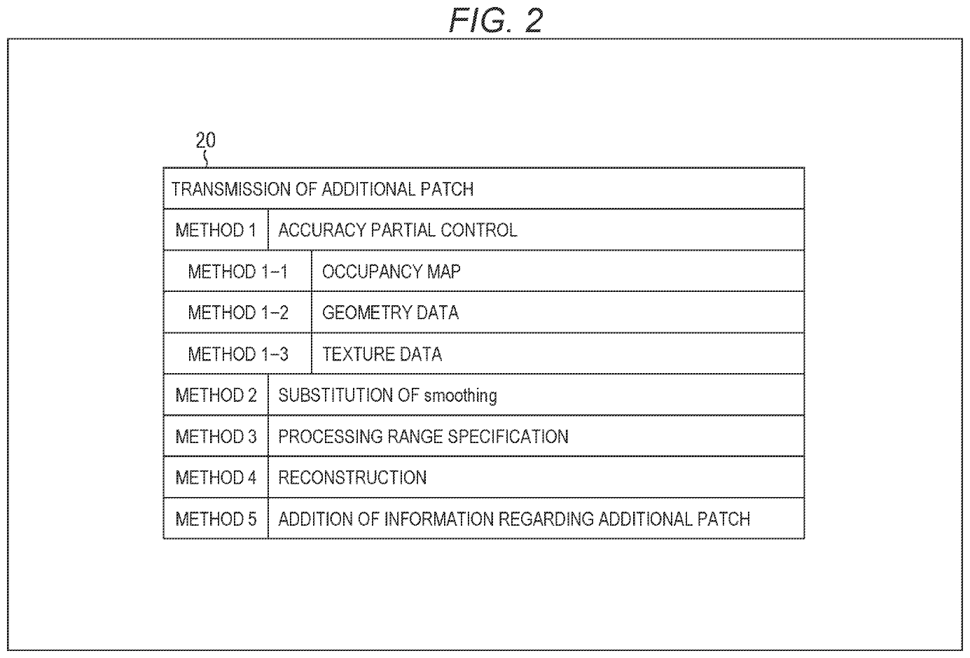

Therefore, in the video-based approach described above, as shown in Table 20 of FIG. 2, an additional patch is to be transmitted. The patch in the video-based approach described in Non Patent Document 2 to Non Patent Document 4 is referred to as a base patch. This base patch is a patch that is always used to reconstruct a partial region of a point cloud including a small region corresponding to the base patch.

On the other hand, a patch other than the base patch is referred to as an additional patch. This additional patch is an optional patch, and is a patch that is not essential for reconstruction of a partial region of a point cloud including a small region corresponding to the additional patch. That is, the point cloud can be reconstructed with only the base patch, or can be reconstructed with both the base patch and the additional patch.

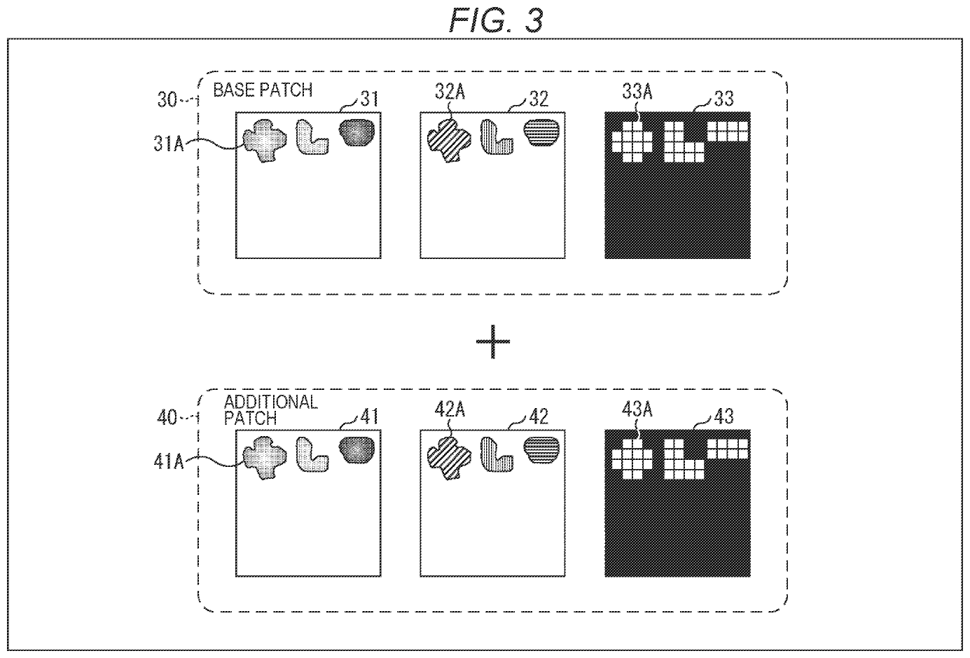

That is, as illustrated in FIG. 3, a base patch 30 and an additional patch 40 are to be transmitted. Similarly to the case of FIG. 1, the base patch 30 is configured by: a patch 31A of geometry data arranged in a geometry video frame 31, a patch 32A of attribute data arranged in a color video frame 32; and a patch 33A of an occupancy map arranged in an occupancy map 33.

Similarly, the additional patch 40 may be configured by a patch 41A of geometry data, a patch 42A of attribute data, and a patch 43A of an occupancy map, but some of these may be omitted. For example, the additional patch 40 may be configured by any one of the patch 41A of the geometry data, the patch 42A of the attribute data, and the patch 43A of the occupancy map, and any of the patch 41A of the geometry data, the patch 42A of the attribute data, and the patch 43A of the occupancy map may be omitted. Note that any small region of the point cloud corresponding to the additional patch 40 may be adopted, and may include at least a part of a small region of a point cloud corresponding to the base patch 30, or may include a region other than the small region of the point cloud corresponding to the base patch 30. Of course, the small region corresponding to the additional patch 40 may completely match the small region corresponding to the base patch 30, or may not overlap with the small region corresponding to the base patch 30.

Note that the base patch 30 and the additional patch 40 can be arranged in the mutually same video frame. However, in the following, for convenience of description, it is assumed that the base patch 30 and the additional patch 40 are arranged in different video frames. Furthermore, the video frame in which the additional patch is arranged is also referred to as an additional video frame. For example, an additional video frame in which the patch 41A is arranged is also referred to as an additional geometry video frame 41. Furthermore, an additional video frame in which the patch 42A is arranged is also referred to as an additional color video frame 42. Moreover, an additional video frame (an occupancy map) in which the patch 43A is arranged is also referred to as an additional occupancy map 43.

The additional patch may be used for updating information on the base patch. In other words, the additional patch may be configured by information to be used for updating information on the base patch.

For example, as in “Method 1” shown in Table 20 of FIG. 2, this additional patch may be used for local control (partial control) of accuracy of information on the base patch. In other words, the additional patch may be configured by information to be used for local control of accuracy of the information on the base patch. For example, an additional patch configured by information with higher accuracy than the base patch may be transmitted together with the base patch, and the information on the base patch may be updated on the reception side by using the additional patch, to enable to locally improve the accuracy of the information on the base patch. By doing in this way, the quality of the point cloud reconstructed using the base patch whose information has been updated can be locally improved.

Note that any parameter may be adopted for controlling the accuracy in this manner, and resolution or a bit depth may be used, for example. Furthermore, as in “Method 1-1” shown in Table 20 of FIG. 2, this additional patch may be a patch of an occupancy map. That is, the additional video frame may be an additional occupancy map. Moreover, as in “Method 1-2” shown in Table 20 of FIG. 2, this additional patch may be a patch of geometry data. That is, the additional video frame may be an additional geometry video frame. Furthermore, as in “Method 1-3” shown in Table 20 of FIG. 2, this additional patch may be a patch of attribute data. That is, the additional video frame may be an additional color video frame. Note that these “Method 1-1” to “Method 1-3” can be applied in any combination.

Furthermore, for example, as in “Method 2” shown in Table 20 of FIG. 2, this additional patch may be used as a substitute for the smoothing process (smoothing). In other words, the additional patch may be configured by information corresponding to a smoothing process (smoothing) result. For example, such an additional patch may be transmitted together with the base patch, and a reception side may update information on the base patch by using the additional patch to obtain the base patch after the smoothing process. By doing in this way, it is possible to reconstruct a point cloud reflecting the smoothing process without performing the smoothing process on the reception side. That is, it is possible to suppress an increase in load due to the smoothing process.

Furthermore, for example, as in “Method 3” shown in Table 20 of FIG. 2, this additional patch may be used to specify a range of processing to be performed on the base patch. In other words, the additional patch may be configured by information specifying a range of processing to be performed on the base patch. Any contents of this processing may be adopted. For example, the range of the smoothing process may be specified by the additional patch. For example, such an additional patch and a base patch may be transmitted, and the smoothing process may be performed on the range of the base patch specified by the additional patch, on the reception side. By doing in this way, it is not necessary to search for a region to be subjected to the smoothing process, and an increase in load can be suppressed.

In a case of each of the above “Method 1” to “Method 3”, the additional patch is different from the base patch in at least some of parameters such as, for example, accuracy of information and a corresponding small region. Furthermore, the additional patch may be configured by geometry data and attribute data projected on the same projection plane as the projection plane of the base patch, or an occupancy map corresponding to the geometry data and the attribute data.

Furthermore, for example, as in “Method 4” shown in Table 20 in FIG. 2, this additional patch may be used for point cloud reconstruction similarly to a base patch. In other words, the additional patch may be configured by information to be used for point cloud reconstruction similarly to a base patch. For example, such an additional patch may be transmitted together with the base patch, and it may be made possible to select whether to reconstruct the point cloud by using only the base patch or to reconstruct the point cloud by using the base patch and the additional patch, on the reception side. By doing in this way, quality of the point cloud can be controlled in accordance with various conditions. Note that, in this case, the attribute data may be omitted in the additional patch. That is, the additional patch may be configured by a patch of geometry data and a patch of an occupancy map. That is, the additional video frame may be configured by a geometry video frame and an occupancy map.

Furthermore, for example, as in “Method 5” shown in Table 20 of FIG. 2, information regarding the additional patch may be transmitted as auxiliary patch information. By referring to this information, the reception side can more accurately grasp characteristics of the additional patch. Any content of the information regarding the additional patch may be adopted. For example, as the information regarding the additional patch, flag information indicating whether the patch is an additional patch may be transmitted as the auxiliary patch information. By referring to this flag information, the reception side can more easily identify the additional patch and the base patch.

This “Method 5” can be applied in combination with each method of “Method 1” to “Method 4” described above. Note that, in a case of each method of “Method 1” to “Method 3”, the information regarding the base patch included in the auxiliary patch information may also be applied to the additional patch. In that case, the information regarding the additional patch can be omitted.

<Action of Additional Patch>

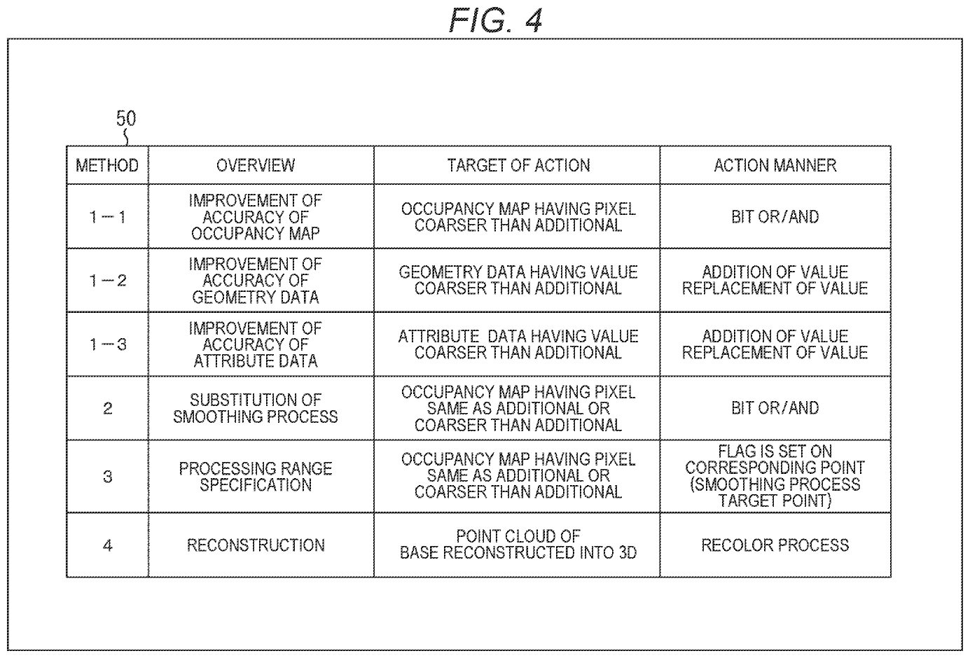

Table 50 shown in FIG. 4 summarizes an action target and an action manner of each method described above. For example, in a case of “Method 1-1” of locally improving accuracy (resolution) of an occupancy map by using an additional patch, the additional patch is a patch of the occupancy map and acts on a base patch of an occupancy map having a pixel (resolution) coarser than the additional patch. For example, information on the base patch is updated by performing a bit-wise logical operation (for example, logical sum (OR) or logical product (AND)) with the additional patch. For example, a region indicated by the additional patch is added to a region indicated by the base patch, or a region indicated by the additional patch is deleted from a region indicated by the base patch. That is, by this logical operation, the accuracy (resolution) of the occupancy map can be locally improved.

Furthermore, in a case of “Method 1-2” of locally improving accuracy (resolution) of geometry data by using an additional patch, the additional patch is a patch of the geometry data and acts on a base patch of geometry data having a value (a bit depth) coarser than the additional patch. For example, information on the base patch is updated by adding a value of the base patch and a value of the additional patch, subtracting a value of the additional patch from a value of the base patch, or replacing a value of the base patch with a value of the additional patch. That is, the accuracy (the bit depth) of the geometry data can be locally improved by such an operation and replacement.

Moreover, in a case of “Method 1-3” of locally improving accuracy (resolution) of attribute data by using an additional patch, the additional patch is a patch of the attribute data and acts on a base patch of attribute data having a value (a bit depth) coarser than the additional patch. For example, information on the base patch is updated by adding a value of the base patch and a value of the additional patch, subtracting a value of the additional patch from a value of the base patch, or replacing a value of the base patch with a value of the additional patch. That is, the accuracy (the bit depth) of attribute data can be locally improved by such an operation and replacement.

Furthermore, in a case of “Method 2” of obtaining a smoothing process result by using an additional patch, the additional patch is a patch of an occupancy map and acts either on a base patch of an occupancy map having a pixel (resolution) same as the additional patch, or on a base patch of an occupancy map having a pixel (resolution) coarser than the additional patch. For example, information on the base patch is updated by performing a bit-wise logical operation (for example, logical sum (OR) or logical product (AND)) with the additional patch. For example, by adding a region indicated by the additional patch to a region indicated by the base patch, or deleting a region indicated by the additional patch from a region indicated by the base patch, a base patch subjected to the smoothing process is obtained. As a result, an increase in load can be suppressed.

Moreover, in a case of “Method 3” of specifying a processing range by using an additional patch, the additional patch is a patch of an occupancy map and acts either on a base patch of an occupancy map having a pixel (resolution) same as the additional patch, or on a base patch of an occupancy map having a pixel (resolution) coarser than the additional patch. For example, the additional patch sets a flag in a processing target range (for example, a smoothing process target range), and the smoothing process is performed on the range indicated by the additional patch in the base patch. As a result, an increase in load can be suppressed.

Furthermore, in a case of “Method 4” of reconstructing a point cloud by using an additional patch, similarly to a base patch, the additional patch is a patch to be used for point cloud reconstruction and acts on a point cloud reconstructed using the base patch. For example, the additional patch is configured by a patch of an occupancy map and a patch of geometry data, and a recolor process is performed using the point cloud reconstructed by the base patch, in order to reconstruct the attribute data.

### 2. First Embodiment (Method 1)

<Method 1-1>

In the present embodiment, the above-described “Method 1” will be described. First, “Method 1-1” will be described. In a case of this “Method 1-1”, patches of occupancy maps of a plurality of types of accuracy are generated from patches of geometry data.

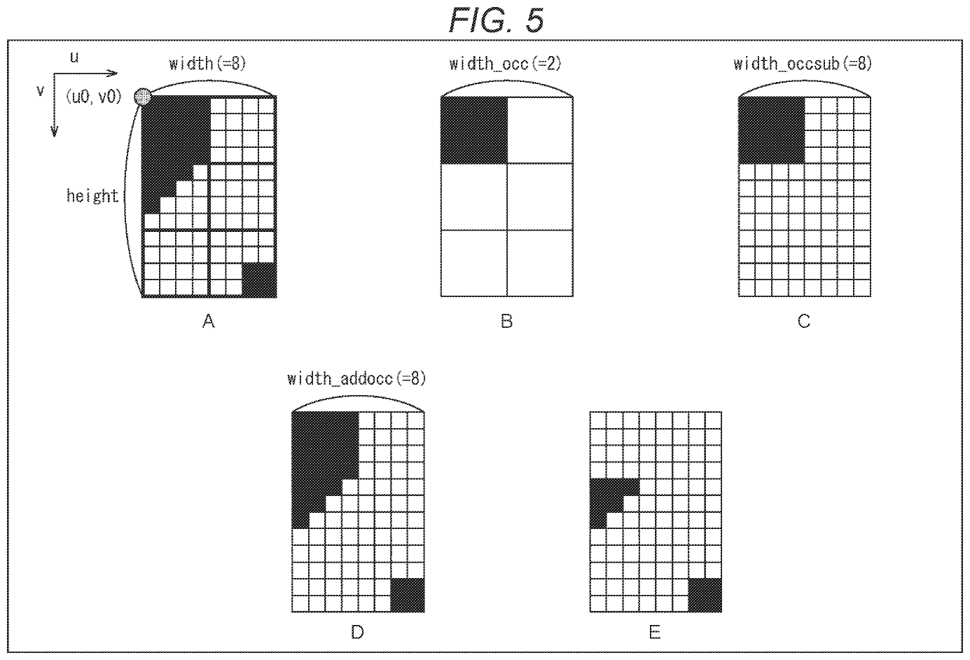

For example, a patch of a low-accuracy occupancy map as illustrated in B of FIG. 5 is generated from a patch of geometry data as illustrated in A of FIG. 5. This patch is set as a base patch. By doing in this way, encoding efficiency can be improved. However, in this case, precision of a range of the geometry data indicated by the occupancy map is reduced. Note that, when this base patch is represented by accuracy of the patch of the geometry data, C of FIG. 5 is obtained.

Meanwhile, when an occupancy map is generated from the patch of the geometry data illustrated in A of FIG. 5 with the same accuracy (the same resolution) as the geometry data, D of FIG. 5 is obtained. In this case, the occupancy map can more accurately represent a range of the geometry data, but an information amount of the occupancy map is increased.

Therefore, a difference between the patch illustrated in D of FIG. 5 and the base patch illustrated in C of FIG. 5 is derived (E of FIG. 5), and this is set as an additional patch. That is, the base patch illustrated in B of FIG. 5 and the additional patch illustrated in E of FIG. 5 are to be transmitted. From these patches, a patch as illustrated in D of FIG. 5 can be obtained on the reception side. That is, the accuracy of the base patch can be improved. That is, by transmitting the additional patch, the accuracy of the point cloud can be locally improved.

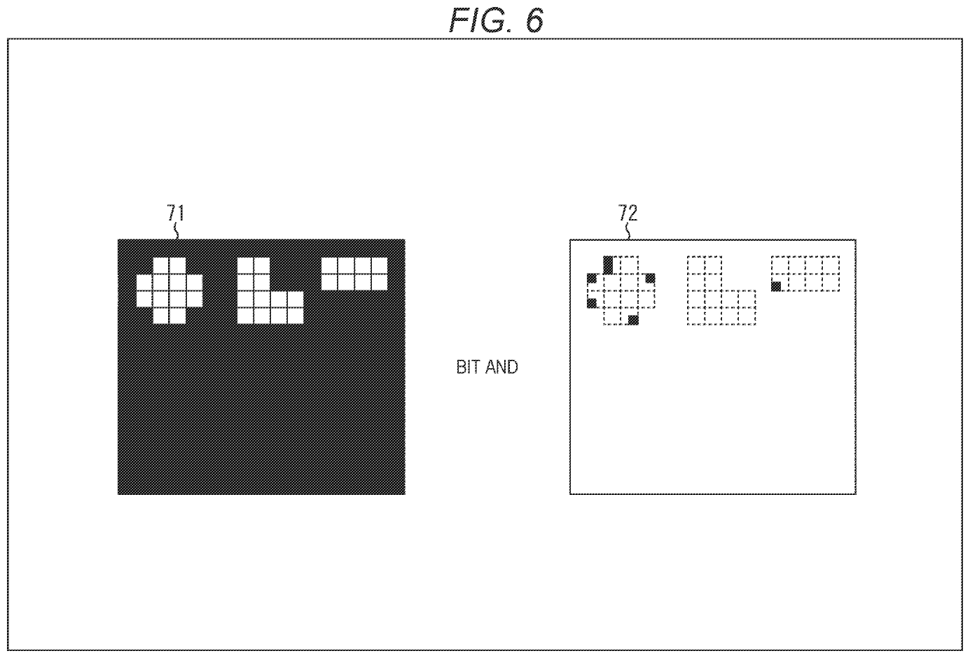

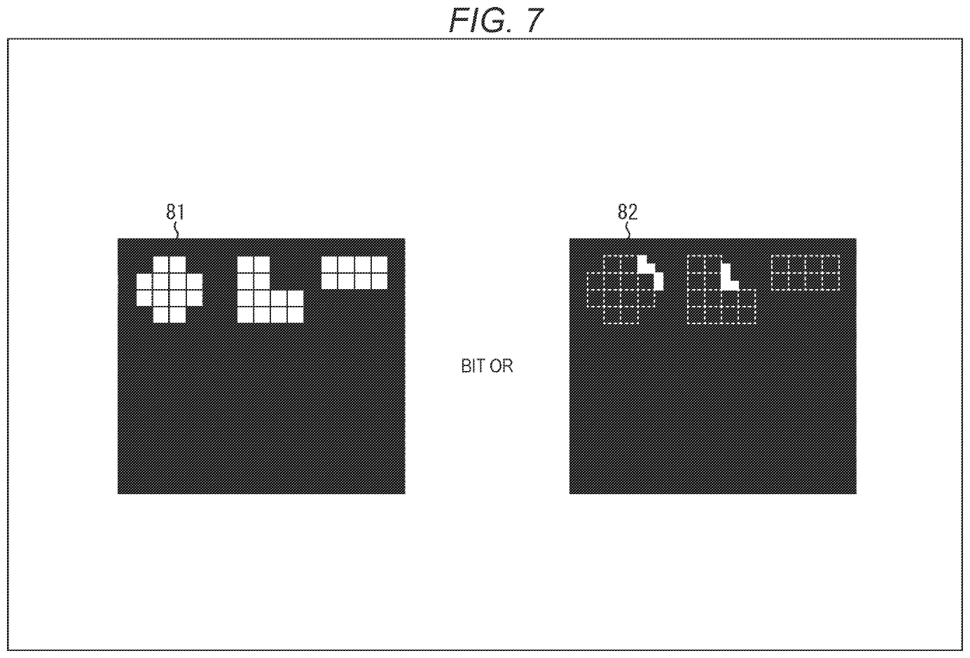

This difference (a region indicated by the additional patch) may be a region to be deleted from a region indicated by the base patch, or may be a region to be added to the region indicated by the base patch. In a case where the additional patch indicates a region to be deleted from the region indicated by the base patch, for example, as illustrated in FIG. 6, by performing a bit-wise logical product (AND) of an occupancy map 71 of the base patch and an occupancy map 72 of the additional patch, a region obtained by deleting the region indicated by the additional patch from the region indicated by the base patch is derived. Furthermore, in a case where the additional patch indicates a region to be added to the region indicated by the base patch, for example, as illustrated in FIG. 7, by performing a bit-wise logical sum (OR) of an occupancy map 81 of the base patch and an occupancy map 82 of the additional patch, a region obtained by adding the region indicated by the additional patch to the region indicated by the base patch is derived.

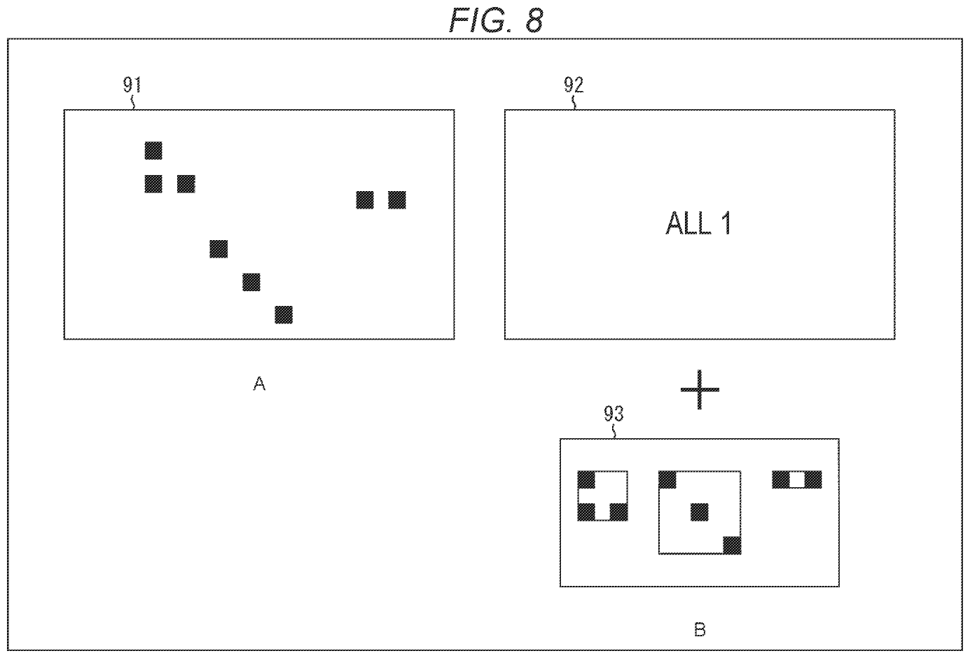

Note that, for example, as illustrated in A of FIG. 8, in a case where a bit of “0” or a bit of “1” is locally present in an occupancy map 91, as illustrated in B of FIG. 8, the occupancy map in which all bits are “1” or an occupancy map 92 in which all bits are “0” may be used as the occupancy map of the base patch. Then, an occupancy map 93 (B of FIG. 8) of bits having locally different values in the occupancy map 91 may be used as the occupancy map of the additional patch. In this case, the occupancy map 92 (B of FIG. 8) of the base patch may be made also known on the reception side, and the transmission thereof may be omitted. That is, it is also possible to transmit only the occupancy map 93 illustrated in B of FIG. 8. By doing in this way, it is possible to suppress an increase in encoding amount of the occupancy map.

<Encoding Device>

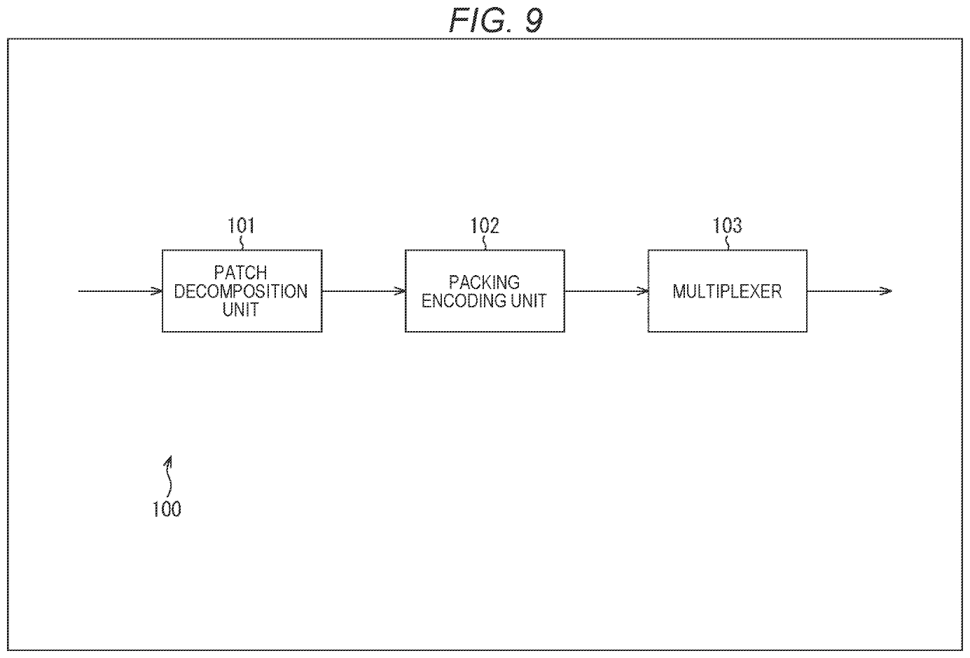

Next, an encoding device that performs such “Method 1-1” will be described. FIG. 9 is a block diagram illustrating an example of a configuration of an encoding device to which the present technology is applied. An encoding device 100 illustrated in FIG. 9 is a device (an encoding device to which a video-based approach is applied) that projects 3D data such as a point cloud onto a two-dimensional plane and performs encoding by an encoding method for a two-dimensional image. The encoding device 100 performs such processing by applying “Method 1-1” in Table 20 in FIG. 2.

Note that, in FIG. 9, main parts of processing units, data flows, and the like are illustrated, and those illustrated in FIG. 9 are not necessarily all. That is, in the encoding device 100, there may be a processing unit not illustrated as a block in FIG. 9, or there may be a flow of processing or data not illustrated as an arrow or the like in FIG. 9.

As illustrated in FIG. 9, the encoding device 100 includes a patch decomposition unit 101, a packing encoding unit 102, and a multiplexer 103.

The patch decomposition unit 101 performs processing related to decomposition of 3D data. For example, the patch decomposition unit 101 may acquire 3D data (for example, a point cloud) representing a three-dimensional structure to be inputted to the encoding device 100. Furthermore, the patch decomposition unit 101 decomposes the acquired 3D data into a plurality of small regions (connection components), projects the 3D data on a two-dimensional plane for every small region, and generates a patch of geometry data and a patch of attribute data.

Furthermore, the patch decomposition unit 101 also generates an occupancy map corresponding to these generated patches. At that time, the patch decomposition unit 101 applies the above-described “Method 1-1” to generate a base patch and an additional patch of the occupancy map. That is, the patch decomposition unit 101 generates an additional patch that locally improves accuracy (resolution) of the base patch of the occupancy map.

The patch decomposition unit 101 supplies the individual generated patches (a base patch of geometry data and attribute data, and a base patch and an additional patch of an occupancy map) to the packing encoding unit 102.

The packing encoding unit 102 performs processing related to data packing and encoding. For example, the packing encoding unit 102 acquires the base patch and the additional patch supplied from the patch decomposition unit 101, arranges each patch in a two-dimensional image, and performs packing as a video frame. For example, the packing encoding unit 102 packs a base patch of geometry data as a video frame, to generate a geometry video frame(s). Furthermore, the packing encoding unit 102 packs a base patch of attribute data as a video frame, to generate a color video frame(s). Moreover, the packing encoding unit 102 generates an occupancy map in which a base patch is arranged and an additional occupancy map in which an additional patch is arranged, which correspond to these video frames.

Furthermore, the packing encoding unit 102 encodes each of the generated video frames (the geometry video frame, the color video frame, the occupancy map, the additional occupancy map) to generate coded data.

Moreover, the packing encoding unit 102 generates auxiliary patch information, which is information regarding a patch, encodes (compresses) the auxiliary patch information, and generates coded data. The packing encoding unit 102 supplies the generated coded data to the multiplexer 103.

The multiplexer 103 performs processing related to multiplexing. For example, the multiplexer 103 acquires various types of coded data supplied from the packing encoding unit 102, and multiplexes the coded data to generate a bitstream. The multiplexer 103 outputs the generated bitstream to the outside of the encoding device 100.

<Packing Encoding Unit>

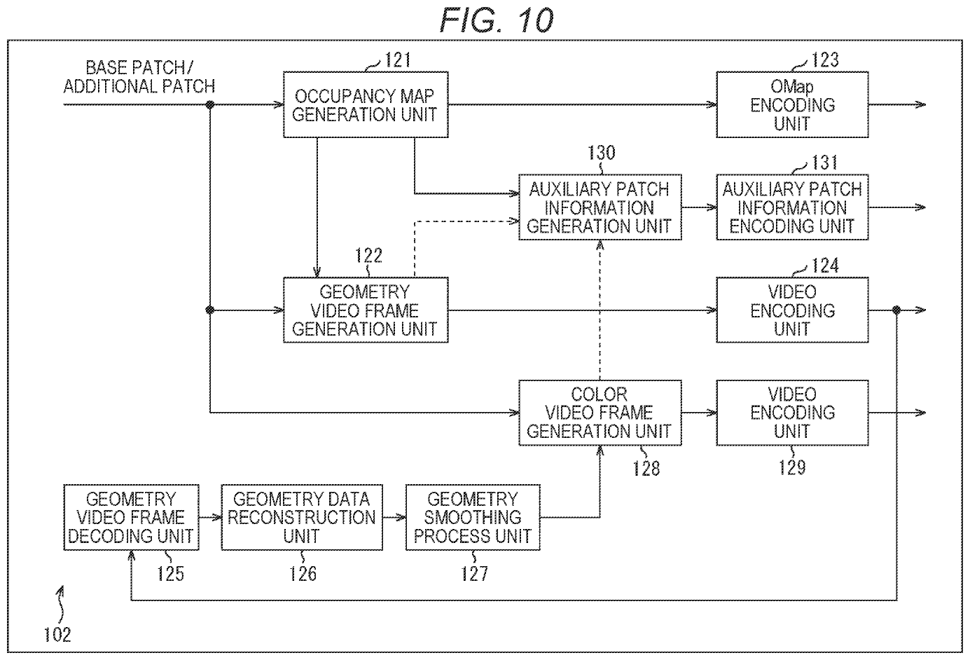

FIG. 10 is a block diagram illustrating a main configuration example of the packing encoding unit 102. Note that, in FIG. 10, main parts of processing units, data flows, and the like are illustrated, and those illustrated in FIG. 10 are not necessarily all. That is, in the packing encoding unit 102, there may be a processing unit not illustrated as a block in FIG. 10, or there may be a flow of processing or data not illustrated as an arrow or the like in FIG. 10.

As illustrated in FIG. 10, the packing encoding unit 102 includes an occupancy map generation unit 121, a geometry video frame generation unit 122, and an OMap encoding unit 123, a video encoding unit 124, a geometry video frame decoding unit 125, a geometry data reconstruction unit 126, a geometry smoothing process unit 127, a color video frame generation unit 128, a video encoding unit 129, an auxiliary patch information generation unit 130, and an auxiliary patch information encoding unit 131.

The occupancy map generation unit 121 generates an occupancy map corresponding to a video frame in which a base patch supplied from a patch decomposition unit 111 is arranged. Furthermore, the occupancy map generation unit 121 generates an additional occupancy map corresponding to an additional video frame in which an additional patch similarly supplied from the patch decomposition unit 111 is arranged.

The occupancy map generation unit 121 supplies the generated occupancy map and additional occupancy map to the OMap encoding unit 123. Furthermore, the occupancy map generation unit 121 supplies the generated occupancy map to the geometry video frame generation unit 122. Moreover, the occupancy map generation unit 121 supplies information regarding the base patch and the additional patch to the auxiliary patch information generation unit 130.

The geometry video frame generation unit 122 generates a geometry video frame, which is a video frame in which a base patch of geometry data supplied from the patch decomposition unit 111 is arranged. The geometry video frame generation unit 122 supplies the generated geometry video frame to the video encoding unit 124.

The OMap encoding unit 123 encodes the occupancy map supplied from the occupancy map generation unit 121 by an encoding method for a two-dimensional image, to generate coded data thereof. Furthermore, the OMap encoding unit 123 encodes the additional occupancy map supplied from the occupancy map generation unit 121 by an encoding method for a two-dimensional image, to generate coded data thereof. The OMap encoding unit 123 supplies the coded data to the multiplexer 103.

The video encoding unit 124 encodes the geometry video frame supplied from the geometry video frame generation unit 122 by an encoding method for a two-dimensional image, to generate coded data thereof. The video encoding unit 124 supplies the generated coded data to the multiplexer 103. Furthermore, the video encoding unit 124 also supplies the generated coded data to the geometry video frame decoding unit 125.

The geometry video frame decoding unit 125 decodes the coded data supplied from the video encoding unit 124 by a decoding method for a two-dimensional image corresponding to the encoding method applied by the video encoding unit 124, to generate (restore) a geometry video frame. The geometry video frame decoding unit 125 supplies the generated (restored) geometry video frame to the geometry data reconstruction unit 126.

The geometry data reconstruction unit 126 extracts a base patch of geometry data from the geometry video frame supplied from the geometry video frame decoding unit 125, and reconstructs geometry data of a point cloud by using the base patch. That is, each point is arranged in a three-dimensional space. The geometry data reconstruction unit 126 supplies the reconstructed geometry data to the geometry smoothing process unit 127.

The geometry smoothing process unit 127 performs smoothing process on the geometry data supplied from the geometry data reconstruction unit 126, to reduce burrs and the like at patch boundaries. The geometry smoothing process unit 127 supplies the geometry data after the smoothing process, to the color video frame generation unit 128.

By performing the recolor process and the like, the color video frame generation unit 128 makes the base patch of the attribute data supplied from the patch decomposition unit 111 to correspond to the geometry data supplied from the geometry smoothing process unit 127, and generates a color video frame that is a video frame in which the base patch is arranged. The color video frame generation unit 128 supplies the generated color video frame to the video encoding unit 129.

The video encoding unit 129 encodes the color video frame supplied from the color video frame generation unit 128 by an encoding method for a two-dimensional image, to generate coded data thereof. The video encoding unit 129 supplies the generated coded data to the multiplexer 103.

The auxiliary patch information generation unit 130 generates auxiliary patch information by using information regarding a base patch and an additional patch of the occupancy map supplied from the occupancy map generation unit 121. The auxiliary patch information generation unit 130 supplies the generated auxiliary patch information to the auxiliary patch information encoding unit 131.

The auxiliary patch information encoding unit 131 encodes the auxiliary patch information supplied from the auxiliary patch information generation unit 130 by any encoding method, to generate coded data thereof. The auxiliary patch information encoding unit 131 supplies the generated coded data to the multiplexer 103.

<Flow of Encoding Process>

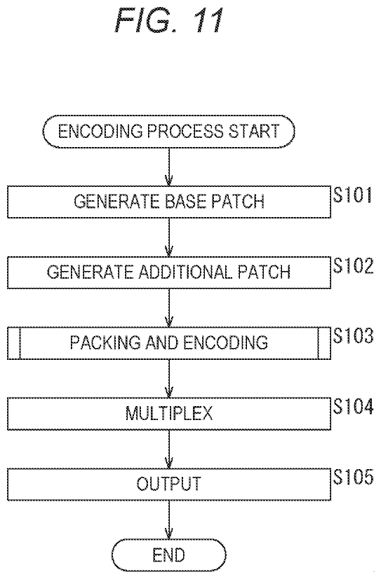

An example of a flow of an encoding process executed by the encoding device 100 having such a configuration will be described with reference to a flowchart of FIG. 11.

When the encoding process is started, the patch decomposition unit 101 of the encoding device 100 generates a base patch in step S101. Furthermore, in step S102, the patch decomposition unit 101 generates an additional patch. In this case, the encoding device 100 applies “Method 1-1” in Table 20 in FIG. 2, and thus generates a base patch and an additional patch of an occupancy map.

In step S103, the packing encoding unit 102 executes a packing encoding process to pack the base patch and the additional patch, and encode the generated video frame.

In step S104, the multiplexer 103 multiplexes the various types of coded data generated in step S102, to generate a bitstream. In step 3105, the multiplexer 103 outputs the bitstream to the outside of the encoding device 100. When the processing in step 3105 ends, the encoding process ends.

<Flow of Packing Encoding Process>

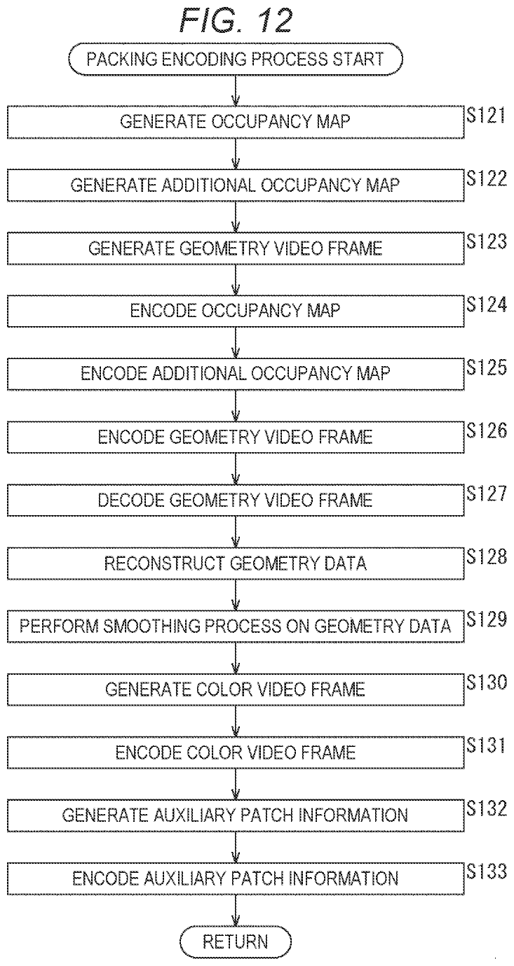

Next, with reference to a flowchart of FIG. 12, an example of a flow of a packing encoding process executed in step S103 in FIG. 11 will be described.

When the packing encoding process is started, in step 3121, the occupancy map generation unit 121 generates an occupancy map by using the base patch generated in step S101 of FIG. 11. Furthermore, in step S122, the occupancy map generation unit 121 generates an additional occupancy map by using the additional patch generated in step S102 in FIG. 11. Moreover, in step S123, the geometry video frame generation unit 122 generates a geometry video frame by using the base patch generated in step S101 of FIG. 11.

In step S124, the OMap encoding unit 123 encodes the occupancy map generated in step S121 by an encoding method for a two-dimensional image, to generate coded data thereof. Furthermore, in step S125, the OMap encoding unit 123 encodes the additional occupancy map generated in step S122 by an encoding method for a two-dimensional image, to generate coded data thereof.

In step S126, the video encoding unit 124 encodes the geometry video frame generated in step S123 by an encoding method for a two-dimensional image, to generate coded data thereof. Furthermore, in step S127, the geometry video frame decoding unit 125 decodes the coded data generated in step S126 by a decoding method for a two-dimensional image corresponding to the encoding method, to generate (restore) a geometry video frame.

In step S128, the geometry data reconstruction unit 126 unpacks the geometry video frame generated (restored) in step S127, to reconstruct geometry data.

In step S129, the geometry smoothing process unit 127 performs the smoothing process on the geometry data reconstructed in step S128, to suppress burrs and the like at patch boundaries.

In step S130, the color video frame generation unit 128 makes attribute data to correspond to a geometry smoothing process result by the recolor process or the like, and generates a color video frame in which the base patch is arranged. Furthermore, in step S131, the video encoding unit 129 encodes the color video frame by an encoding method for a two-dimensional image, to generate coded data.

In step S132, the auxiliary patch information generation unit 130 generates auxiliary patch information by using information regarding the base patch and the additional patch of the occupancy map. In step S133, the auxiliary patch information encoding unit 131 encodes the generated auxiliary patch information by any encoding method, to generate coded data.

When the process of step S133 ends, the packing encoding process ends, and the process returns to FIG. 11.

By executing each process as described above, the encoding device 100 can generate the occupancy map and the additional occupancy map for improving the accuracy of the occupancy map. Therefore, the encoding device 100 can locally improve the accuracy of the occupancy map.

As a result, it is possible to suppress deterioration of quality of a reconstructed point cloud while suppressing deterioration of encoding efficiency and suppressing an increase in load. That is, it is possible to suppress deterioration of image quality of a two-dimensional image for displaying 3D data.

<Decoding Device>

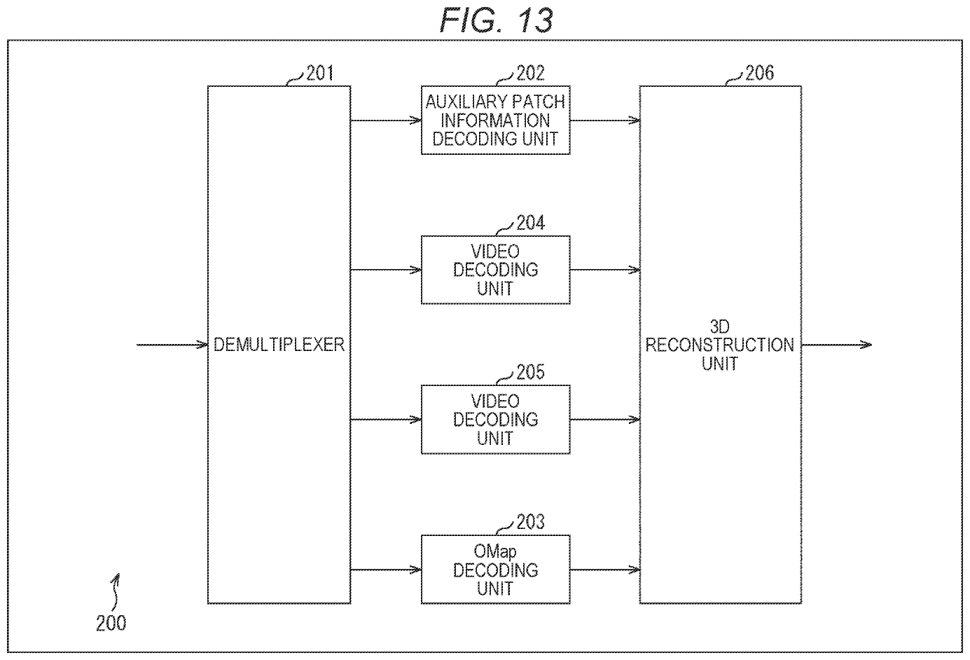

FIG. 13 is a block diagram illustrating an example of a configuration of a decoding device, which is one mode of an image processing apparatus to which the present technology is applied. A decoding device 200 illustrated in FIG. 13 is a device (a decoding device to which a video-based approach is applied) configured to reconstruct 3D data by decoding, with a decoding method for a two-dimensional image, coded data obtained by projecting 3D data such as a point cloud onto a two-dimensional plane and encoding the 3D data. The decoding device 200 is a decoding device corresponding to the encoding device 100 in FIG. 9, and can reconstruct 3D data by decoding a bitstream generated by the encoding device 100. That is, this decoding device 200 performs such processing by applying “Method 1-1” in Table 20 in FIG. 2.

Note that, in FIG. 13, main parts of processing units, data flows, and the like are illustrated, and those illustrated in FIG. 13 are not necessarily all. That is, in the decoding device 200, there may be a processing unit not illustrated as a block in FIG. 13, or there may be a flow of processing or data not illustrated as an arrow or the like in FIG. 13.

As illustrated in FIG. 13, the decoding device 200 includes a demultiplexer 201, an auxiliary patch information decoding unit 202, an OMap decoding unit 203, a video decoding unit 204, a video decoding unit 205, and a 3D reconstruction unit 206.

The demultiplexer 201 performs processing related to demultiplexing of data. For example, the demultiplexer 201 can acquire a bitstream inputted to the decoding device 200. This bitstream is supplied from the encoding device 100, for example.

Furthermore, the demultiplexer 201 can demultiplex this bitstream. For example, the demultiplexer 201 can extract coded data of auxiliary patch information from the bitstream by demultiplexing. Furthermore, the demultiplexer 201 can extract coded data of a geometry video frame from the bitstream by demultiplexing. Moreover, the demultiplexer 201 can extract coded data of a color video frame from the bitstream by demultiplexing. Furthermore, the demultiplexer 201 can extract coded data of an occupancy map and coded data of an additional occupancy map from the bitstream by demultiplexing.

Moreover, the demultiplexer 201 can supply the extracted data to a processing unit in a subsequent stage. For example, the demultiplexer 201 can supply the extracted coded data of the auxiliary patch information to the auxiliary patch information decoding unit 202 Furthermore, the demultiplexer 201 can supply the extracted coded data of the geometry video frame to the video decoding unit 204. Moreover, the demultiplexer 201 can supply the extracted coded data of the color video frame to the video decoding unit 205. Furthermore, the demultiplexer 201 can supply coded data of the occupancy map and coded data of the additional occupancy map, which have been extracted, to the OMap decoding unit 203.

The auxiliary patch information decoding unit 202 performs processing related to decoding of coded data of auxiliary patch information. For example, the auxiliary patch information decoding unit 202 can acquire coded data of auxiliary patch information supplied from the demultiplexer 201. Furthermore, the auxiliary patch information decoding unit 202 can decode the coded data to generate the auxiliary patch information. Any decoding method may be adopted as long as the decoding method corresponds to the encoding method (for example, the encoding method applied by the auxiliary patch information encoding unit 131) applied at a time of encoding. Moreover, the auxiliary patch information decoding unit 202 can supply the generated auxiliary patch information to the 3D reconstruction unit 206.

The OMap decoding unit 203 performs processing related to decoding of coded data of the occupancy map and coded data of the additional occupancy map. For example, the OMap decoding unit 203 can acquire coded data of the occupancy map and coded data of the additional occupancy map that are supplied from the demultiplexer 201. Furthermore, the OMap decoding unit 203 can decode these pieces of coded data to generate an occupancy map and an additional occupancy map. Moreover, the OMap decoding unit 203 can supply the occupancy map and the additional occupancy map to the 3D reconstruction unit 206.

The video decoding unit 204 performs processing related to decoding of coded data of a geometry video frame. For example, the video decoding unit 204 can acquire coded data of a geometry video frame supplied from the demultiplexer 201. Furthermore, the video decoding unit 204 can decode the coded data to generate the geometry video frame. Any decoding method may be adopted as long as the decoding method is for a two-dimensional image and corresponds to the encoding method (for example, the encoding method applied by the video encoding unit 124) applied at a time of encoding. Moreover, the video decoding unit 204 can supply the geometry video frame to the 3D reconstruction unit 206.

The video decoding unit 205 performs processing related to decoding of coded data of a color video frame. For example, the video decoding unit 205 can acquire coded data of a color video frame supplied from the demultiplexer 201. Furthermore, the video decoding unit 205 can decode the coded data to generate the color video frame. Any decoding method may be adopted as long as the decoding method is for a two-dimensional image and corresponds to the encoding method (for example, the encoding method applied by the video encoding unit 129) applied at a time of encoding. Moreover, the video decoding unit 205 can supply the color video frame to the 3D reconstruction unit 206.

The 3D reconstruction unit 206 performs processing related to unpacking of a video frame and reconstruction of 3D data. For example, the 3D reconstruction unit 206 can acquire auxiliary patch information supplied from the auxiliary patch information decoding unit 202. Furthermore, the 3D reconstruction unit 206 can acquire an occupancy map supplied from the OMap decoding unit 203. Moreover, the 3D reconstruction unit 206 can acquire a geometry video frame supplied from the video decoding unit 204. Furthermore, the 3D reconstruction unit 206 can acquire a color video frame supplied from the video decoding unit 205. Moreover, the 3D reconstruction unit 206 may unpack those video frames to reconstruct 3D data (for example, a point cloud). The 3D reconstruction unit 206 outputs the 3D data obtained by such processing to the outside of the decoding device 200. For example, the 3D data is supplied to a display unit to display an image, recorded on a recording medium, or supplied to another device via communication.

<3D Reconstruction Unit>

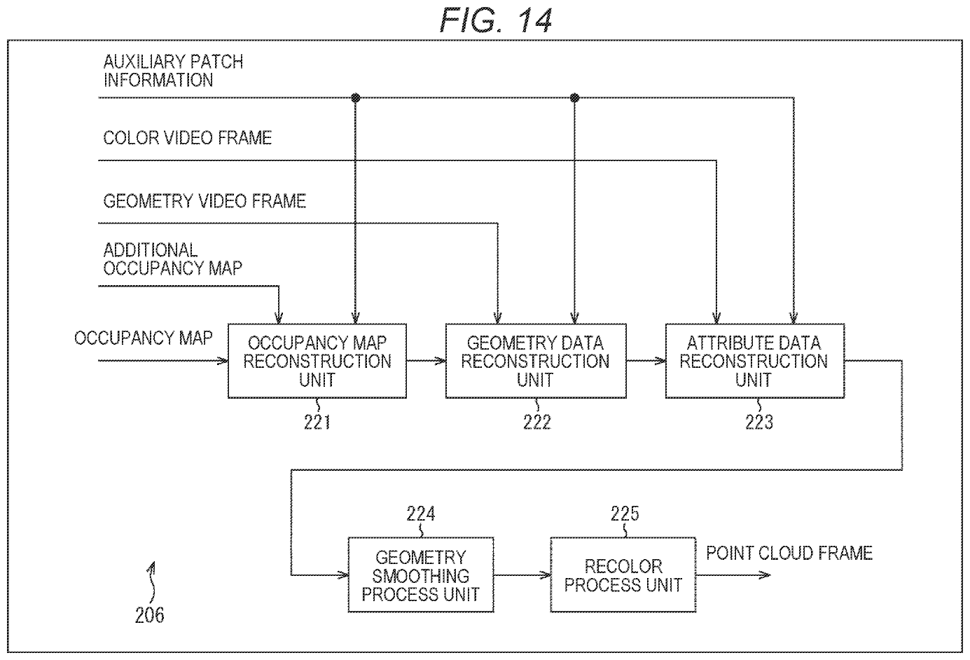

FIG. 14 is a block diagram illustrating a main configuration example of the 3D reconstruction unit 206. Note that, in FIG. 14, main parts of processing units, data flows, and the like are illustrated, and those illustrated in FIG. 14 are not necessarily all. That is, in the 3D reconstruction unit 206, there may be a processing unit not illustrated as a block in FIG. 14, or there may be a flow of processing or data not illustrated as an arrow or the like in FIG. 14.

As illustrated in FIG. 14, the 3D reconstruction unit 206 includes an occupancy map reconstruction unit 221, a geometry data reconstruction unit 222, an attribute data reconstruction unit 223, a geometry smoothing process unit 224, and a recolor process unit 225.

By using auxiliary patch information supplied from the auxiliary patch information decoding unit 202 to perform a bit-wise logical operation (derive a logical sum or a logical product) on an occupancy map and an additional occupancy map that are supplied from the OMap decoding unit 203, the occupancy map reconstruction unit 221 generates a synthesized occupancy map in which the occupancy map and the additional occupancy map are synthesized. The occupancy map generation unit 121 supplies the synthesized occupancy map to the geometry data reconstruction unit 222.

The geometry data reconstruction unit 222 uses the auxiliary patch information supplied from the auxiliary patch information decoding unit 202 and the synthesized occupancy map supplied from the occupancy map reconstruction unit 221, to unpack the geometry video frame supplied from the video decoding unit 204 (FIG. 13) to extract a base patch of geometry data. Furthermore, the geometry data reconstruction unit 222 also reconstructs the geometry data by using the base patch and the auxiliary patch information. Moreover, the geometry data reconstruction unit 222 supplies the reconstructed geometry data and the synthesized occupancy map to the attribute data reconstruction unit 223.

The attribute data reconstruction unit 223 uses the auxiliary patch information supplied from the auxiliary patch information decoding unit 202 and the synthesized occupancy map supplied from the occupancy map reconstruction unit 221, to unpack the color video frame supplied from the video decoding unit 205 (FIG. 13) to extract a base patch of attribute data. Furthermore, the attribute data reconstruction unit 223 also reconstructs the attribute data by using the base patch and the auxiliary patch information. The attribute data reconstruction unit 223 supplies various kinds of information such as the geometry data, the synthesized occupancy map, and the reconstructed attribute data, to the geometry smoothing process unit 224.

The geometry smoothing process unit 224 performs the smoothing process on the geometry data supplied from the attribute data reconstruction unit 223. The geometry smoothing process unit 224 supplies the geometry data subjected to the smoothing process and attribute data, to the recolor process unit 225.

The recolor process unit 225 acquires the geometry data and the attribute data supplied from the geometry smoothing process unit 224, performs the recolor process by using the geometry data and the attribute data, and makes the attribute data to correspond to the geometry data, to generate (reconstruct) a point cloud. The recolor process unit 225 outputs the point cloud to the outside of the decoding device 200.

<Flow of Decoding Process>

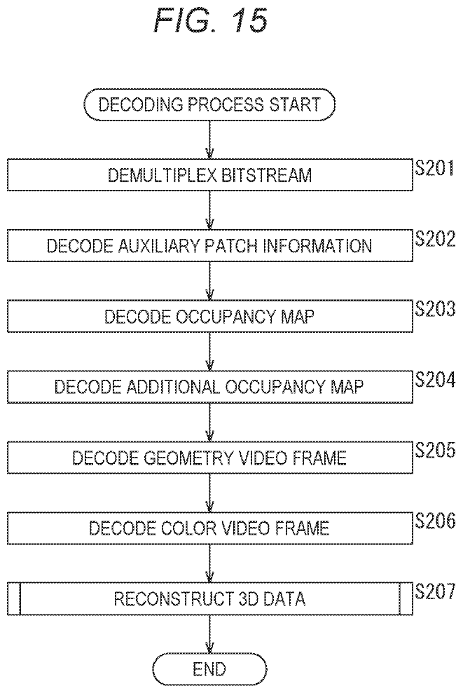

An example of a flow of a decoding process executed by the decoding device 200 having such a configuration will be described with reference to a flowchart of FIG. 15.

When the decoding process is started, in step S201, the demultiplexer 201 of the decoding device 200 demultiplexes a bitstream, and extracts, from the bitstream, auxiliary patch information, an occupancy map, an additional occupancy map, a geometry video frame, a color video frame, and the like.

In step S202, the auxiliary patch information decoding unit 202 decodes coded data of auxiliary patch information extracted from the bitstream by the processing in step S201. In step S203, the OMap decoding unit 203 decodes coded data of an occupancy map extracted from the bitstream by the processing in step S201. Furthermore, in step S204, the OMap decoding unit 203 decodes coded data of the additional occupancy map extracted from the bitstream by the processing in step S201.

In step S205, the video decoding unit 204 decodes coded data of a geometry video frame extracted from the bitstream by the processing in step S201. In step S206, the video decoding unit 205 decodes coded data of a color video frame extracted from the bitstream by the processing in step S201.

In step S207, the 3D reconstruction unit 206 performs the 3D reconstruction process by using information obtained by the processing above, to reconstruct the 3D data. When the process of step S207 ends, the decoding process ends.

<Flow of 3D Reconstruction Process>

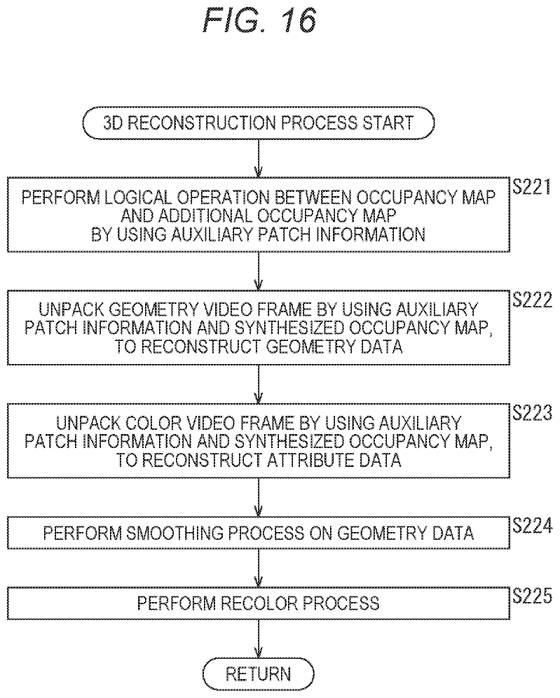

Next, with reference to a flowchart of FIG. 16, an example of a flow of the 3D reconstruction process executed in step S207 of FIG. 15 will be described.

When the 3D reconstruction process is started, in step S221, the occupancy map reconstruction unit 221 performs a bit-wise logical operation (for example, including logical sum and logical product) between the occupancy map and the additional occupancy map by using the auxiliary patch information, to generate a synthesized occupancy map.

In step S222, the geometry data reconstruction unit 222 unpacks the geometry video frame by using the auxiliary patch information and the generated synthesized occupancy map, to reconstruct geometry data.

In step S223, the attribute data reconstruction unit 223 unpacks the color video frame by using the auxiliary patch information and the generated synthesized occupancy map, to reconstruct attribute data.

In step S224, the geometry smoothing process unit 224 performs the smoothing process on the geometry data obtained in step S222.

In step S225, the recolor process unit 225 performs the recolor process, and makes the attribute data reconstructed in step S223 to correspond to the geometry data subjected to the smoothing process in step S224, and reconstructs a point cloud.

When the process of step S225 ends, the 3D reconstruction process ends, and the process returns to FIG. 15.

By executing each process as described above, the decoding device 200 can reconstruct the 3D data by using the occupancy map and the additional occupancy map for improving the accuracy of the occupancy map. Therefore, the decoding device 200 can locally improve the accuracy of the occupancy map. As a result, the decoding device 200 can suppress deterioration of quality of a reconstructed point cloud while suppressing deterioration of encoding efficiency and suppressing an increase in load. That is, it is possible to suppress deterioration of image quality of a two-dimensional image for displaying 3D data.

<Method 1-2>

While “Method 1-1” has been described above, “Method 1-2” can also be similarly implemented. In a case of “Method 1-2”, an additional patch of geometry data is generated. That is, in this case, the geometry video frame generation unit 122 (FIG. 10) generates a geometry video frame in which a base patch of geometry data is arranged and an additional geometry video frame in which an additional patch of geometry data is arranged. The video encoding unit 124 encodes each of the geometry video frame and the additional geometry video frame to generate coded data.

Furthermore, information regarding the base patch and information regarding the additional patch are supplied from the geometry video frame generation unit 122 to the auxiliary patch information generation unit 130, and the auxiliary patch information generation unit 130 generates auxiliary patch information on the basis of these pieces of information.

Furthermore, in the case of this “Method 1-2”, the geometry data reconstruction unit 222 of the decoding device 200 reconstructs geometry data corresponding to the geometry video frame and geometry data corresponding to the additional geometry video frame, and synthesizes these to generate synthesized geometry data. For example, the geometry data reconstruction unit 222 may generate the synthesized geometry data by replacing a value of the geometry data corresponding to the base patch with a value of the geometry data corresponding to the additional patch. Furthermore, the geometry data reconstruction unit 222 may generate the synthesized geometry data by performing addition or subtraction of a value of the geometry data corresponding to the base patch and a value of the geometry data corresponding to the additional patch.

By doing in this way, accuracy of geometry data can be locally improved. Then, by reconstructing a point cloud by using such synthesized geometry data, it is possible to suppress deterioration of quality of a reconstructed point cloud while suppressing deterioration of encoding efficiency and suppressing an increase in load. That is, it is possible to suppress deterioration of image quality of a two-dimensional image for displaying 3D data.

<Method 1-3>

Of course, “Method 1-3” can also be similarly implemented. In a case of “Method 1-3”, an additional patch of attribute data is generated. That is, similarly to the case of the geometry data, by performing addition, subtraction, or replacement of a value of attribute data corresponding to a base patch and a value of attribute data corresponding to an additional patch, synthesized attribute data obtained by synthesizing these can be generated.

Note that, in this case, information regarding the base patch and information regarding the additional patch are supplied from the color video frame generation unit 128 to the auxiliary patch information generation unit 130, and the auxiliary patch information generation unit 130 generates auxiliary patch information on the basis of these pieces of information.

By doing in this way, accuracy of attribute data can be locally improved. Then, by reconstructing a point cloud by using such synthesized attribute data, it is possible to suppress deterioration of quality of a reconstructed point cloud while suppressing deterioration of encoding efficiency and suppressing an increase in load. That is, it is possible to suppress deterioration of image quality of a two-dimensional image for displaying 3D data.

<Combination>

Note that “Method 1” to “Method 3” described above can also be used in combination in any pair. Moreover, all of “Method 1” to “Method 3” described above can also be applied.

### 3. Second Embodiment (Method 2)

<Substitution of Smoothing Process>

In the present embodiment, the above-described “Method 2” will be described. In a case of this “Method 2”, an additional occupancy map (an additional patch) is generated such that a synthesized occupancy map corresponds to a smoothing process result.

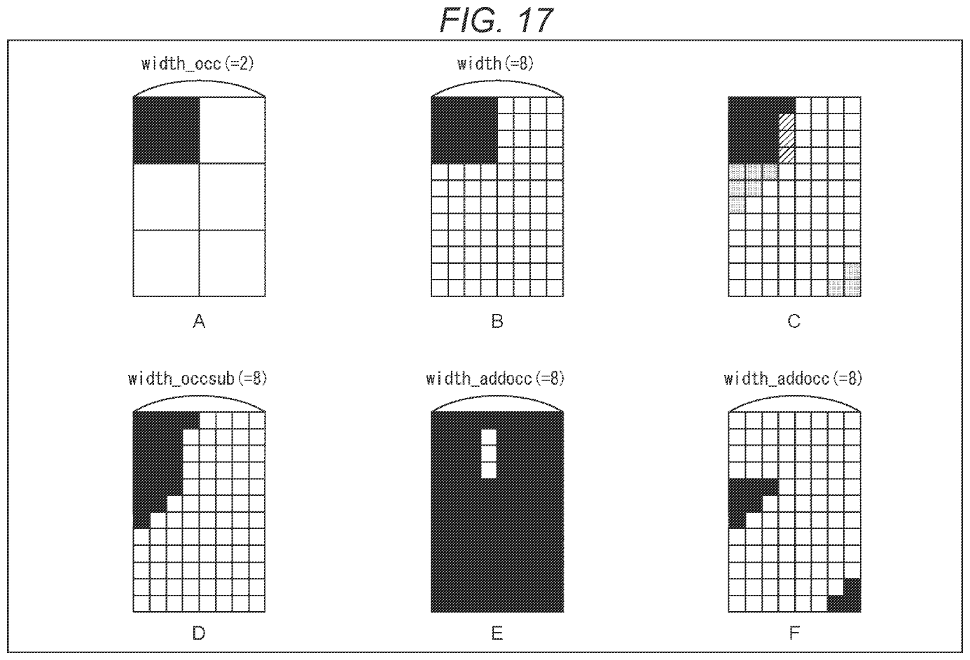

For example, as illustrated in A of FIG. 17, when a base patch of an occupancy map with lower accuracy than geometry data is represented by accuracy of geometry data, B of FIG. 17 is obtained. It is assumed that a patch has a shape as illustrated in C of FIG. 17 when a smoothing process is performed on the geometry data. A hatched region in C of FIG. 17 represents a region to which a point is added in a case where B of FIG. 17 is used as a reference. Furthermore, a gray region represents a region from which a point is deleted in a case where B of FIG. 17 is used as a reference. When this patch is expressed with the same accuracy as the geometry data, the occupancy map is to be as illustrated in D of FIG. 17. In this case, a range of the geometry data can be precisely represented, but a coding amount of the occupancy map increases.

Therefore, an occupancy map for point addition as illustrated in E of FIG. 17 and an occupancy map for point deletion as illustrated in F of FIG. 17 are generated as additional occupancy maps. By transmitting such additional occupancy maps, it is possible to generate an occupancy map reflecting the smoothing process on a decoding side. That is, a smoothing process result of the geometry data is obtained without performing the smoothing process. That is, since the smoothing process can be omitted, an increase in load due to the smoothing process can be suppressed.

<Packing Encoding Unit>

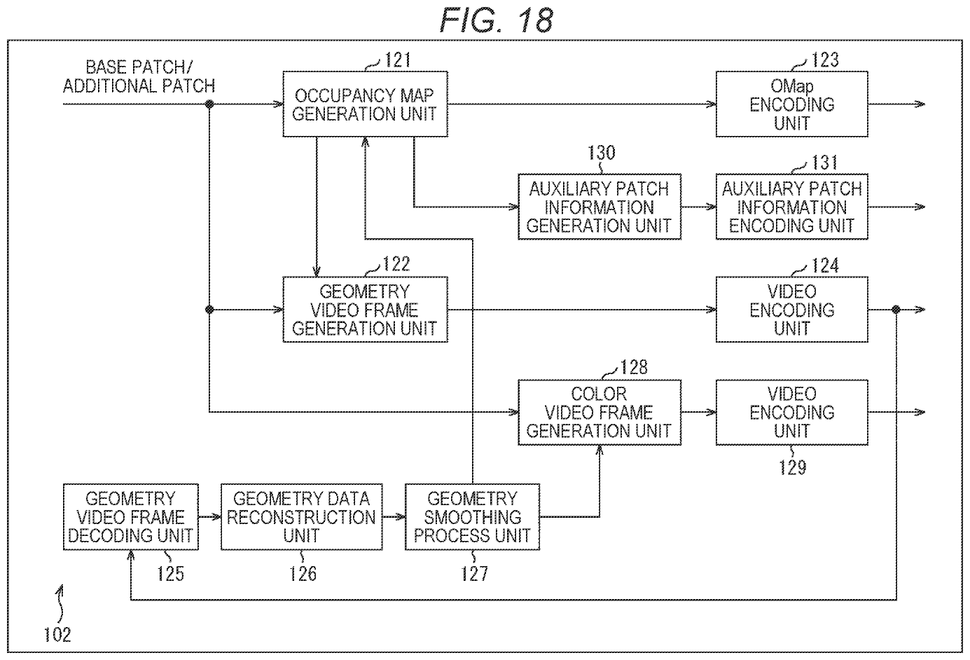

Also in this case, an encoding device 100 has a configuration basically similar to the case of “Method 1-1” (FIG. 9). Furthermore, a main configuration example of a packing encoding unit 102 in this case is illustrated in FIG. 18. As illustrated in FIG. 18, the packing encoding unit 102 in this case has a configuration basically similar to the case of “Method 1-1” (FIG. 10). However, in this case, a geometry smoothing process unit 127 supplies geometry data subjected to the smoothing process, to an occupancy map generation unit 121. The occupancy map generation unit 121 generates an occupancy map corresponding to a base patch, and generates an additional occupancy map on the basis of the geometry data subjected to the smoothing process.

The occupancy map generation unit 121 supplies the generated occupancy map and additional occupancy map to an OMap encoding unit 123. The OMap encoding unit 123 encodes the occupancy map and the additional occupancy map to generate coded data of these.

Furthermore, the occupancy map generation unit 121 supplies information regarding the occupancy map and the additional occupancy map, to an auxiliary patch information generation unit 130. On the basis of these pieces of information, the auxiliary patch information generation unit 130 generates auxiliary patch information including the information regarding the occupancy map and the additional occupancy map. An auxiliary patch information encoding unit 131 encodes the auxiliary patch information generated in this world.

<Flow of Packing Encoding Process>

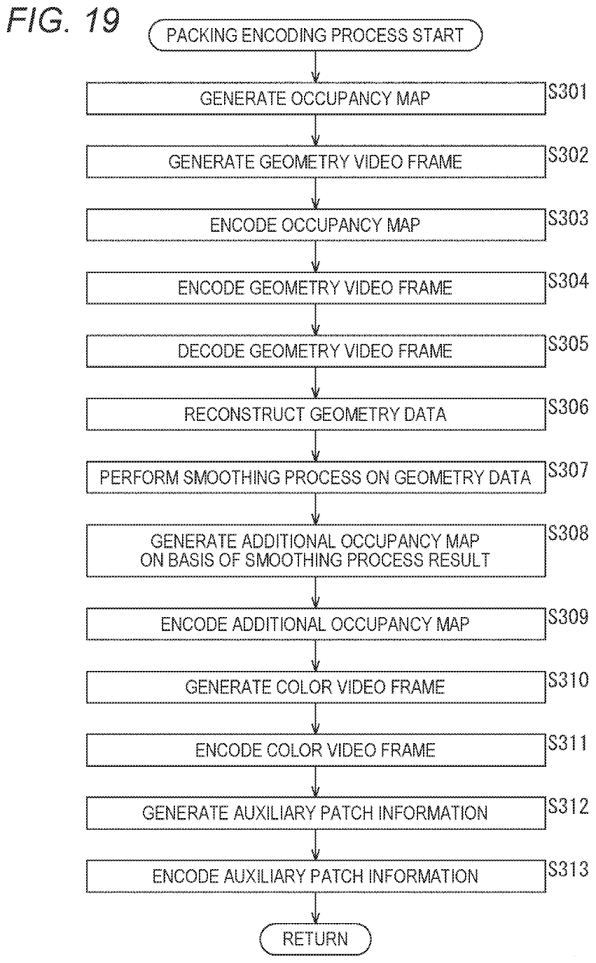

Also in this case, an encoding process is executed by an encoding device 100 in a flow similar to a flowchart of FIG. 11. An example of a flow of the packing encoding process executed in step S103 (FIG. 11) of the encoding process in this case will be described with reference to a flowchart in FIG. 19.

In this case, when the packing encoding process is started, each process of steps S301 to S307 is executed similarly to each process of steps S121, S123, S124, and S126 to S129 of FIG. 12.

In step S308, the occupancy map generation unit 121 generates an additional occupancy map on the basis of a smoothing process result in step S307. That is, for example, as illustrated in FIG. 17, the occupancy map generation unit 121 generates an additional occupancy map indicating a region to be added and a region to be deleted for the occupancy map, in order to be able to more precisely indicate a shape of a patch of the geometry data after the smoothing process. In step S309, the OMap encoding unit 123 encodes the additional occupancy map.

Each process of steps S310 to S313 is executed similarly to each process of steps S130 to S133 of FIG. 12.

As described above, by generating the additional occupancy map on the basis of the smoothing process result and transmitting, the smoothed geometry data subjected to the smoothing process can be reconstructed on a reception side by reconstructing, the geometry data by using the additional occupancy map and the occupancy map. That is, since a point cloud reflecting the smoothing process can be reconstructed without performing the smoothing process on the reception side, an increase in load due to the smoothing process can be suppressed.

<3D Reconstruction Unit>

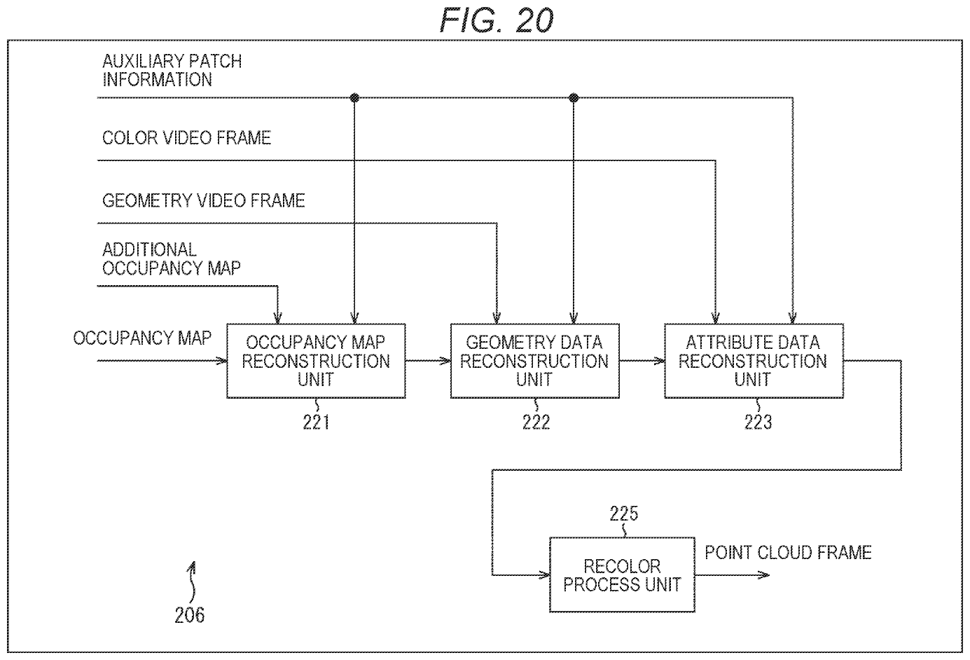

Next, the reception side will be described. Also in this case, a decoding device 200 has a configuration basically similar to the case of “Method 1-1” (FIG. 13). Furthermore, a main configuration example of a 3D reconstruction unit 206 in this case is illustrated in FIG. 20. As illustrated in FIG. 20, the 3D reconstruction unit 206 in this case has a configuration basically similar to the case of “Method 1-1” (FIG. 10). However, in this case, the geometry smoothing process unit 224 is omitted.

When an occupancy map reconstruction unit 221 generates a synthesized occupancy map from an occupancy map and an additional occupancy map, and a geometry data reconstruction unit 222 reconstructs geometry data by using the synthesized occupancy map, the geometry data subjected to the smoothing process is obtained. Therefore, in this case, the geometry smoothing process unit 224 can be omitted.

<Flow of 3D Reconstruction Process>

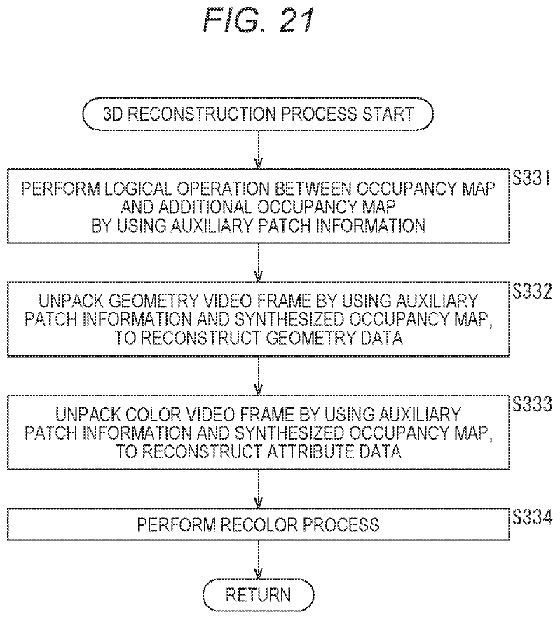

Also in this case, a decoding process is executed by the decoding device 200 in a flow similar to the flowchart of FIG. 15. An example of a flow of the 3D reconstruction process executed in step S207 (FIG. 15) of the decoding process in this case will be described with reference to a flowchart of FIG. 21.

In this case, when the 3D reconstruction process is started, each process of steps S331 to S334 is executed similarly to each process of steps S221 to S225 of FIG. 16. That is, in this case, the geometry data subjected to the smoothing process is obtained by the process of step S332. Therefore, the process of step S224 is omitted.

As described above, since the smoothing process is unnecessary on the reception side, an increase in load can be suppressed.

### 4. Third Embodiment (Method 3)

<Specification of Processing Range>

In the present embodiment, the above-described “Method 3” will be described. In a case of this “Method 3” a target range of processing to be performed on geometry data and attribute data, such as a smoothing process, for example, is specified by an additional occupancy map.

<Flow of Packing Encoding Process>

In this case, an encoding device 100 has a configuration similar to that of the case of “Method 2” (FIG. 9, FIG. 18). Then, an encoding process executed by the encoding device 100 is also executed by a flow similar to the case of “Method 1-1” (FIG. 11).

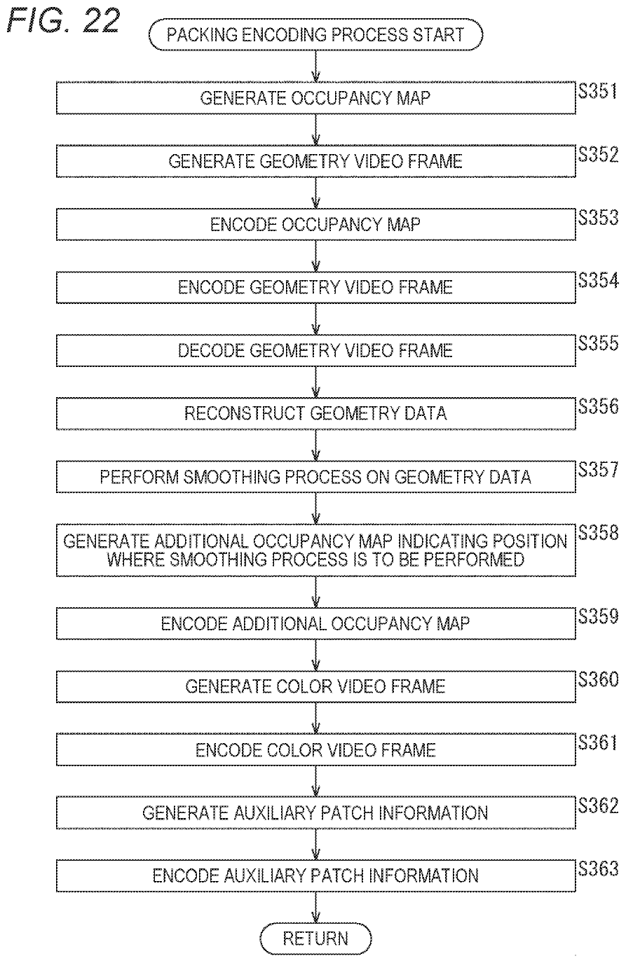

An example of a flow of a packing encoding process in this case will be described with reference to a flowchart of FIG. 22.

When the packing encoding process is started, each process of steps S351 to S357 is performed similarly to each process of steps S301 to S307 of FIG. 19 (in the case of “Method 2”).

In step S358, on the basis of a smoothing process result in step S307, an occupancy map generation unit 121 generates an additional occupancy map indicating a position where the smoothing process is to be performed. That is, the occupancy map generation unit 121 generates the additional occupancy map so as to set a flag in a region where the smoothing process is to be performed.

Then, each process of steps S359 to S363 is executed similarly to each process of steps S309 to S313 of FIG. 19.

As described above, on the basis of a smoothing process result, by generating an additional occupancy map indicating a range where the smoothing process is to be performed, and transmitting, the smoothing process can be more easily performed on the reception side in an appropriate range on the basis of the additional occupancy map. That is, the reception side does not need to search for a range to be subjected to the smoothing process, so that an increase in load can be suppressed.

<Flow of 3D Reconstruction Process>

Next, the reception side will be described. In this case, a decoding device 200 (and a 3D reconstruction unit 206) has a configuration basically similar to that of the case of “Method 1-1” (FIG. 13, FIG. 14). Furthermore, a decoding process in this case is executed by the decoding device 200 in a flow similar to the flowchart in FIG. 15. Then, an example of a flow of the 3D reconstruction process executed in step S207 (FIG. 15) of the decoding process in this case will be described with reference to the flowchart of FIG. 22.

In this case, when the 3D reconstruction process is started, in step S381, a geometry data reconstruction unit 222 unpacks a geometry video frame by using auxiliary patch information and an occupancy map, to reconstruct geometry data.

In step S382, an attribute data reconstruction unit 223 unpacks a color video frame by using the auxiliary patch information and the occupancy map, to reconstruct attribute data.

In step S383, a geometry smoothing process unit 224 performs the smoothing process on the geometry data on the basis of the additional occupancy map. That is, the geometry smoothing process unit 224 performs the smoothing process on a range specified by the additional occupancy map.

In step S384, the recolor process unit 225 performs a recolor process, and makes the attribute data reconstructed in step S382 to correspond to the geometry data subjected to the smoothing process in step S383, and reconstructs a point cloud.

When the process of step S384 ends, the 3D reconstruction process ends, and the process returns to FIG. 15.

As described above, by performing the smoothing process in the range indicated by the additional occupancy map and to be subjected to the smoothing process, the smoothing process can be more easily performed in an appropriate range. That is, the reception side does not need to search for a range to be subjected to the smoothing process, so that an increase in load can be suppressed.

### 5. Fourth Embodiment (Method 4)

<Reconstruction>

In the present embodiment, the above-described “Method 4” will be described. In a case of this “Method 4”, similarly to a base patch, an additional patch to be used for point cloud reconstruction is generated. However, the additional patch is optional and may not be used for reconstruction (a point cloud can be reconstructed only with a base patch without an additional patch).

<Packing Encoding Unit>

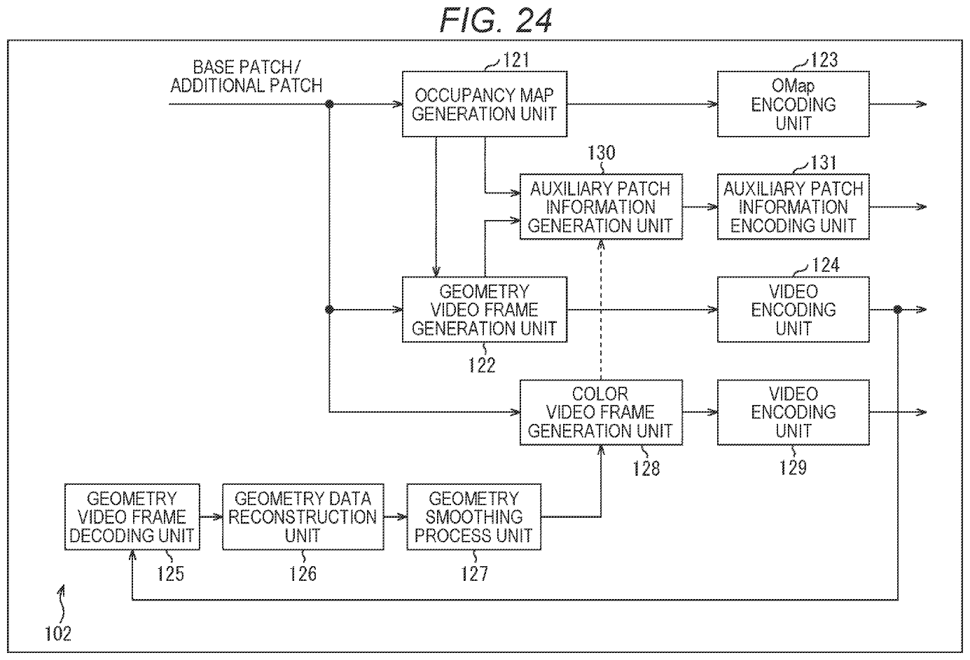

Also in this case, an encoding device 100 has a configuration basically similar to the case of “Method 1-1” (FIG. 9). Furthermore, a main configuration example of a packing encoding unit 102 in this case is illustrated in FIG. 24. As illustrated in FIG. 24, the packing encoding unit 102 in this case has a configuration basically similar to the case of “Method 1-1” (FIG. 10). However, in this case, a patch decomposition unit 101 generates an additional patch of an occupancy map and geometry data. That is, the patch decomposition unit 101 generates the base patch and the additional patch for the occupancy map and the geometry data.

Therefore, an occupancy map generation unit 121 of the packing encoding unit 102 generates an occupancy map corresponding to the base patch and an additional occupancy map corresponding to the additional patch, and a geometry video frame generation unit 122 generates a geometry video frame in which the base patch is arranged and an additional geometry video frame in which the additional patch is arranged.

An auxiliary patch information generation unit 130 acquires information regarding the base patch and information regarding the additional patch from each of the occupancy map generation unit 121 and the geometry video frame generation unit 122, and generates auxiliary patch information including these pieces of information.

An OMap encoding unit 123 encodes the occupancy map and the additional occupancy map generated by the occupancy map generation unit 121. Furthermore, a video encoding unit 124 encodes the geometry video frame and the additional geometry video frame generated by the geometry video frame generation unit 122. An auxiliary patch information encoding unit 131 encodes the auxiliary patch information to generate coded data.

Note that the additional patch may also be generated for attribute data. However, as in the present example, the attribute data may be omitted in the additional patch, and attribute data corresponding to the additional patch may be obtained by a recolor process on the reception side.

<Packing Encoding Process>

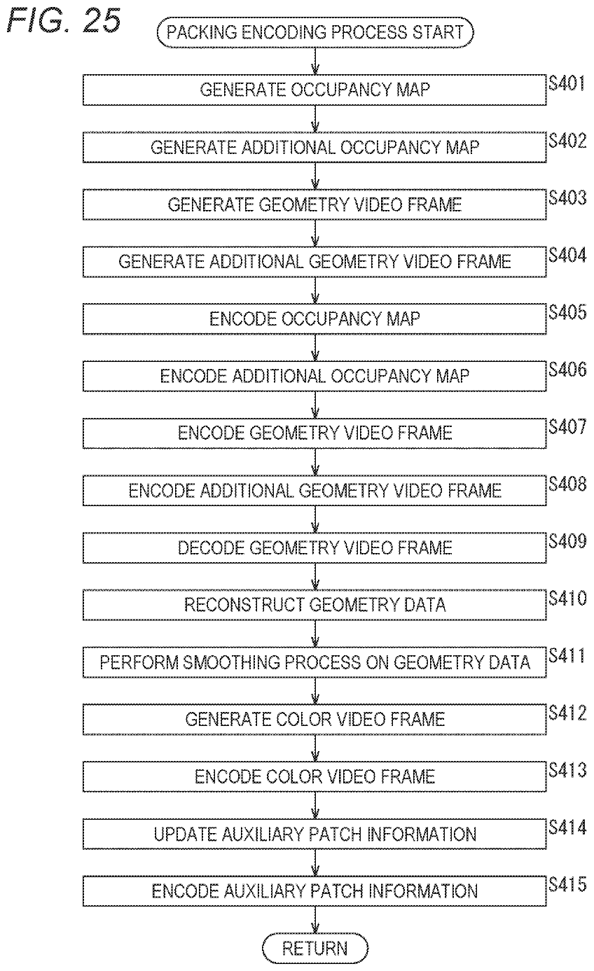

Also in this case, an encoding process is executed by an encoding device 100 in a flow similar to a flowchart of FIG. 11. An example of a flow of a packing encoding process executed in step S103 (FIG. 11) of the encoding process in this case will be described with reference to a flowchart of FIG. 25.

In this case, when the packing encoding process is started, each process of steps S401 to S403 is executed similarly to each process of steps S121 to S123 of FIG. 12.

In step S404, the geometry video frame generation unit 122 generates an additional geometry video frame in which an additional patch is arranged.

Each process of steps S405 to S407 is executed similarly to each process of steps S124 to S126 of FIG. 12.

In step S408, the video encoding unit 124 encodes the additional geometry video frame.

Each process of steps S409 to S415 is executed similarly to each process of steps S127 to S133 of FIG. 12.

That is, in this case, an additional patch of at least geometry data and an occupancy map is generated. As a result, the additional patch can be used to reconstruct a point cloud.

<3D Reconstruction Unit>

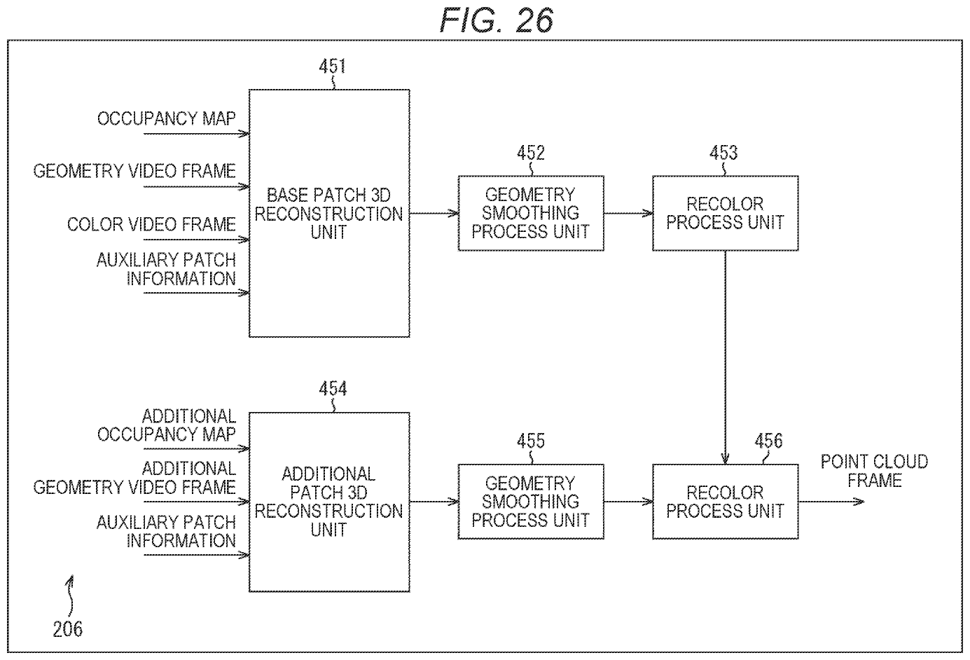

Next, the reception side will be described. Also in this case, a decoding device 200 has a configuration basically similar to the case of “Method 1-1” (FIG. 13). Furthermore, a main configuration example of a 3D reconstruction unit 206 in this case is illustrated in FIG. 26. As illustrated in FIG. 26, the 3D reconstruction unit 206 in this case includes a base patch 3D reconstruction unit 451, a geometry smoothing process unit 452, a recolor process unit 453, an additional patch 3D reconstruction unit 454, a geometry smoothing process unit 455, and a recolor process unit 456.

The base patch 3D reconstruction unit 451, the geometry smoothing process unit 452, and the recolor process unit 453 perform processing related to a base patch. The base patch 3D reconstruction unit 451 uses auxiliary patch information, an occupancy map corresponding to a base patch, a base patch of a geometry video frame, and a base patch of a color video frame, to reconstruct a point cloud (a small region corresponding to the base patch). The geometry smoothing process unit 452 performs a smoothing process on geometry data corresponding to the base patch. The recolor process unit 453 performs a recolor process so that attribute data corresponds to geometry data subjected to the smoothing process.

The additional patch 3D reconstruction unit 454, the geometry smoothing process unit 455, and the recolor process unit 456 perform processing related to an additional patch. The additional patch 3D reconstruction unit 454 uses auxiliary patch information, an additional occupancy map, and an additional geometry video frame (that is, uses an additional patch), to reconstruct a point cloud (a small region corresponding to the additional patch). The geometry smoothing process unit 455 performs the smoothing process on geometry data corresponding to the base patch. The recolor process unit 456 performs the recolor process by using a recolor process result by the recolor process unit 453, that is, attribute data of the base patch. As a result, the recolor process unit 456 synthesizes a point cloud corresponding to the base patch and a point cloud corresponding to the additional patch, to generate and output a point cloud corresponding to the base patch and the additional patch.

<Flow of 3D Reconstruction Process>

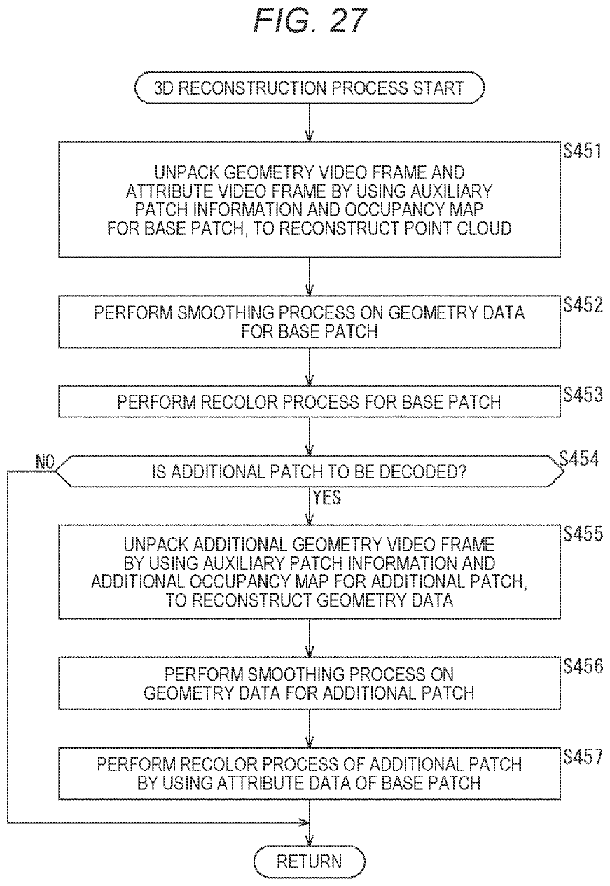

Also in this case, a decoding process is executed by the decoding device 200 in a flow similar to the flowchart of FIG. 15. An example of a flow of the 3D reconstruction process executed in step S207 (FIG. 15) of the decoding process in this case will be described with reference to a flowchart of FIG. 27.

In this case, when the 3D reconstruction process is started, in step S451, the base patch 3D reconstruction unit 451 unpacks the geometry video frame and the color video frame by using the auxiliary patch information and the occupancy map for the base patch, to reconstruct the point cloud corresponding to the base patch.

In step S452, the geometry smoothing process unit 452 performs the smoothing process on the geometry data for the base patch. That is, the geometry smoothing process unit 452 performs the smoothing process on the geometry data of the point cloud obtained in step S451 and corresponding to the base patch.

In step S453, the recolor process unit 453 performs the recolor process for the base patch. That is, the recolor process unit 453 performs the recolor process so that the attribute data of the point cloud obtained in step S451 and corresponding to the base patch corresponds to the geometry data.

In step S454, the additional patch 3D reconstruction unit 454 determines whether or not to decode the additional patch on the basis of, for example, the auxiliary patch information and the like. For example, in a case where there is an additional patch and it is determined to decode the additional patch, the process proceeds to step S455.

In step S455, the additional patch 3D reconstruction unit 454 unpacks the additional geometry video frame by using the auxiliary patch information and the additional occupancy map for the additional patch, to reconstruct geometry data corresponding to the additional patch.

In step S456, the geometry smoothing process unit 455 performs the smoothing process on the geometry data for the additional patch. That is, the geometry smoothing process unit 455 performs the smoothing process on the geometry data of the point cloud obtained in step S455 and corresponding to the additional patch.

In step S457, the recolor process unit 456 performs the recolor process of the additional patch by using the attribute data of the base patch. That is, the recolor process unit 456 makes the attribute data of the base patch to correspond to the geometry data obtained by the smoothing process in step S456.

By executing each process in this manner, a point cloud corresponding to the base patch and the additional patch is reconstructed. When the process of step S457 ends, the 3D reconstruction process ends. Furthermore, in a case where it is determined not to decode the additional patch in step S454, the 3D reconstruction process ends. That is, the point cloud corresponding to the base patch is outputted.

As described above, since a point cloud can be reconstructed using an additional patch, the point cloud can be reconstructed with more various methods.

### 6. Fifth Embodiment (Method 5)

<Auxiliary Patch Information>

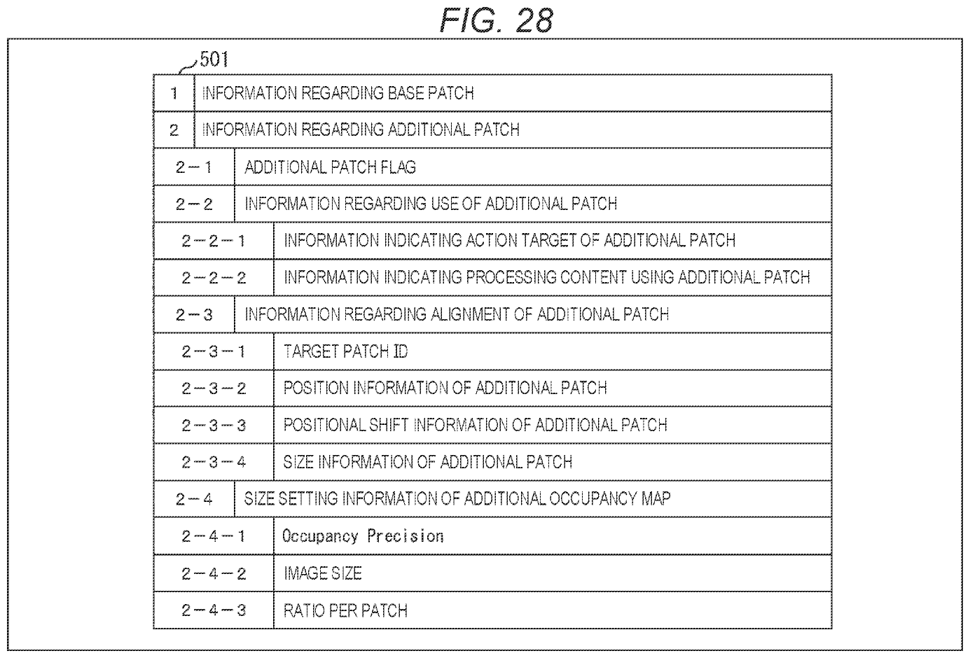

As described above, in a case where an additional patch is applied, for example, as shown in Table 501 illustrated in FIG. 28, in the auxiliary patch information, “2. Information regarding additional patch” may be transmitted in addition to “1. Information regarding base patch”.

“2. Information regarding additional patch” may have any contents. For example, “2-1. Additional patch flag” may be included. This additional patch flag is flag information indicating whether or not a corresponding patch is an additional patch. For example, in a case where the additional patch flag is “true (1)”, it indicates that the corresponding patch is an additional patch. By referring to this flag information, an additional patch and a base patch can be more easily identified.

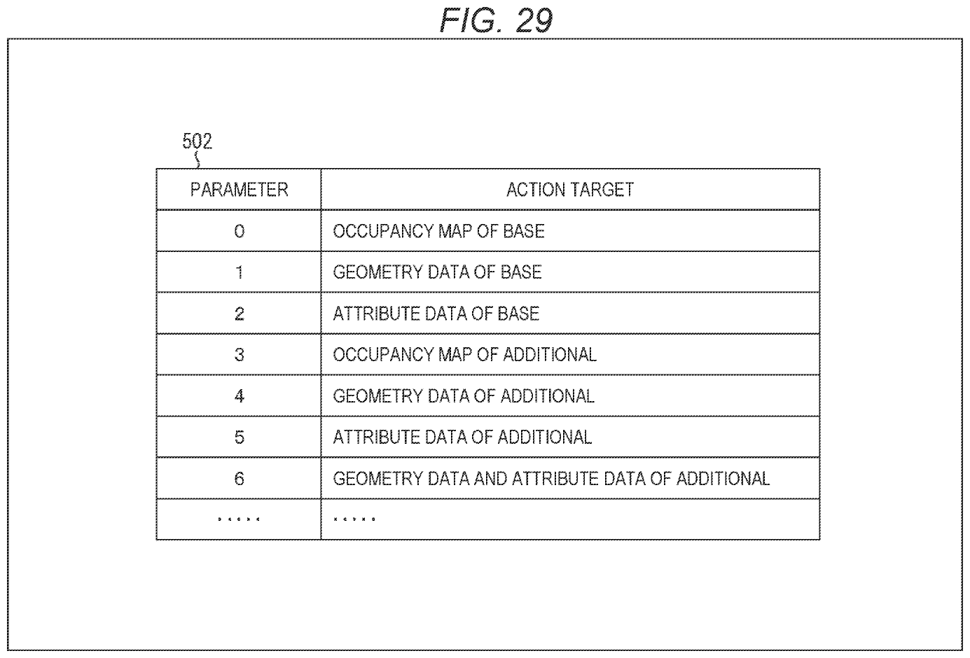

Furthermore, “2-2. Information regarding use of additional patch” may be included in “2. Information regarding additional patch”. As “2-2. Information regarding use of additional patch”, for example, “2-2-1. Information indicating action target of additional patch” may be included. This “2-2-1. Information indicating action target of additional patch” indicates what kind of data is to be affected by the additional patch depending on a value of a parameter as in Table 502 in FIG. 29, for example.

In a case of the example of FIG. 29, when the value of the parameter is “0”, it indicates that the action target of the additional patch is an occupancy map corresponding to a base patch. Furthermore, when the value of the parameter is “1”, it indicates that the action target of the additional patch is a base patch of geometry data. Moreover, when the value of the parameter is “2”, it indicates that the action target of the additional patch is a base patch of attribute data. Furthermore, when the value of the parameter is “3”, it indicates that the action target of the additional patch is an occupancy map corresponding to the additional patch. Moreover, when the value of the parameter is “4”, it indicates that the action target of the additional patch is an additional patch of geometry data. Furthermore, when the value of the parameter is “5”, it indicates that the action target of the additional patch is an additional patch of attribute data. Moreover, when the value of the parameter is “6”, it indicates that the action target of the additional patch is an additional patch of geometry data and attribute data.

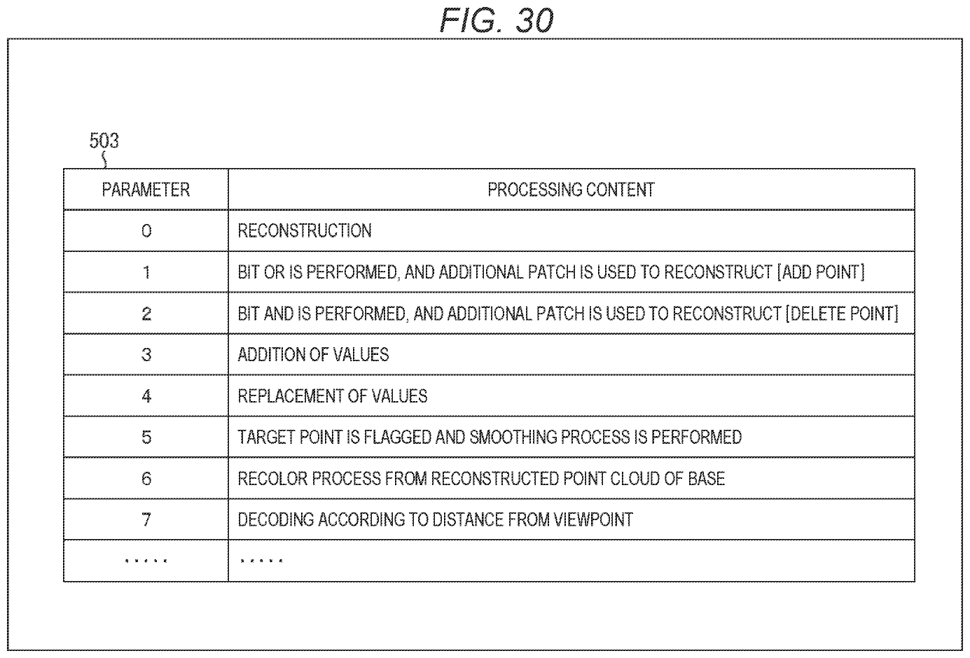

Furthermore, returning to FIG. 28, as “2-2. Information regarding use of additional patch”, for example, “2-2-2. Information indicating processing content using additional patch” may be included. For example, as shown in Table 503 of FIG. 30, “2-2-2. Information indicating processing content using additional patch” indicates what kind of processing in which the additional patch is used depending on a value of a parameter.

In the example of FIG. 30, in a case where the value of the parameter is “0”, it indicates that the additional patch is used for point cloud reconstruction. Furthermore, when the value of the parameter is “1”, it indicates that the additional patch is used for point addition. That is, in this case, a bit-wise logical product (OR) is derived by the base patch and the additional patch. Moreover, when the value of the parameter is “2”, it indicates that the additional patch is used for point deletion. That is, in this case, a bit-wise logical sum (AND) is derived by the base patch and the additional patch.

Furthermore, when the value of the parameter is “3”, it indicates that a value of the additional patch and a value of the base patch are added. Moreover, when the value of the parameter is “4”, it indicates that a value of the base patch is replaced with a value of the additional patch.

Furthermore, when the value of the parameter is “5”, it indicates that a target point is flagged and a smoothing process is performed. Moreover, when the value of the parameter is “6”, it indicates that a recolor process is performed from a reconstructed point cloud corresponding to the base patch. Furthermore, when the value of the parameter is “7”, it indicates that the additional patch is decoded in accordance with a distance from a viewpoint.

Returning to FIG. 28, “2-3. Information regarding alignment of additional patch” may be included in “2. Information regarding additional patch”. As “2-3. Information regarding alignment of additional patch”, for example, information such as “2-3-1. Target patch ID”, “2-3-2. Position information of additional patch”, “2-3-3. Positional shift information of additional patch”, and “2-3-4. Size information of additional patch” may be included.

For example, in a case where positions of the base patch and the additional patch are different, “2-3-1. Target patch ID” and “2-3-2. Position information of additional patch” may be included in “2. Information regarding additional patch”.

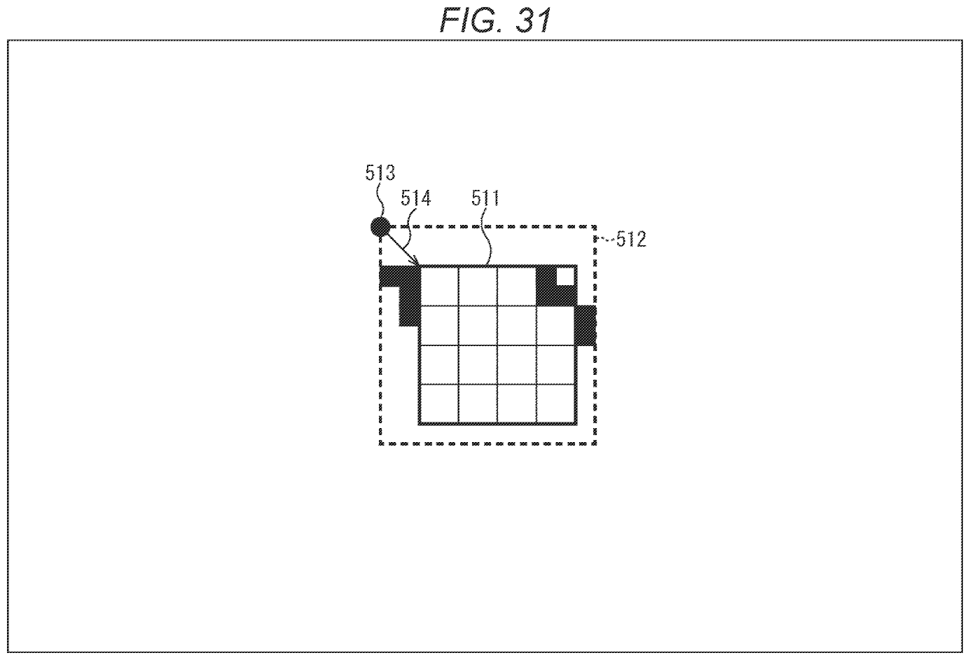

“2-3-1. Target patch ID” is identification information (patchIndex) of a target patch. “2-3-2. Position information of additional patch” is information indicating a position of the additional patch on an occupancy map, and is indicated by two-dimensional plane coordinates such as, for example, (u0′, v0′). For example, in FIG. 31, it is assumed that an additional patch corresponding to a base patch 511 is an additional patch 512. At this time, coordinates of an upper left point 513 of the additional patch 512 are “2-3-2. Position information of additional patch”. Note that “2-3-2. Position information of additional patch” may be represented by a shift amount (Δu0, Δv0) from a position (u0, v0) of a base patch as indicated by an arrow 514 in FIG. 31. Note that Δu0=u0−u0′ and Δv0=v0−v0′ are satisfied.

Furthermore, for example, in a case where sizes of the base patch and the additional patch are different, “2-3-3. Positional shift information of additional patch” and “2-3-4. Size information of additional patch” may be included in “2. Information regarding additional patch”.

“2-3-3. Positional shift information of additional patch” is a shift amount of a position due to a size change. In a case of the example of FIG. 31, the arrow 514 corresponds to “2-3-3. Positional shift information of additional patch”. That is, this “2-3-3. Positional shift information of additional patch” is represented by (Δu0, Δv0).

“2-3-4. Size information of additional patch” indicates a patch size after a change. That is, it is information indicating a size of the additional patch 512 indicated by a dotted line in FIG. 31, and is indicated by a width and a height such as, for example, w′ and h′. Note that “2-3-4. Size information of additional patch” may be represented by differences Δw and Δh from the base patch. Note that Δw=w−w′ and Δh=h−h′ are satisfied.

Note that, by sharing patch information with the base patch, transmission of alignment information can be omitted.

Furthermore, returning to FIG. 28, “2-4. Size setting information of additional occupancy map” may be included in “2. Information regarding additional patch”. As “2-4. Size setting information of additional occupancy map”, “2-4-1. Occupancy precision” indicating accuracy of the occupancy map, “2-4-2. Image size”, “2-4-3. Ratio per patch”, and the like may be included.

That is, as before, the accuracy of the additional occupancy map may be represented by “2-4-1. Occupancy precision”, may be represented by “2-4-2. Image size”, or may be represented by “2-4-3. Ratio per patch”.

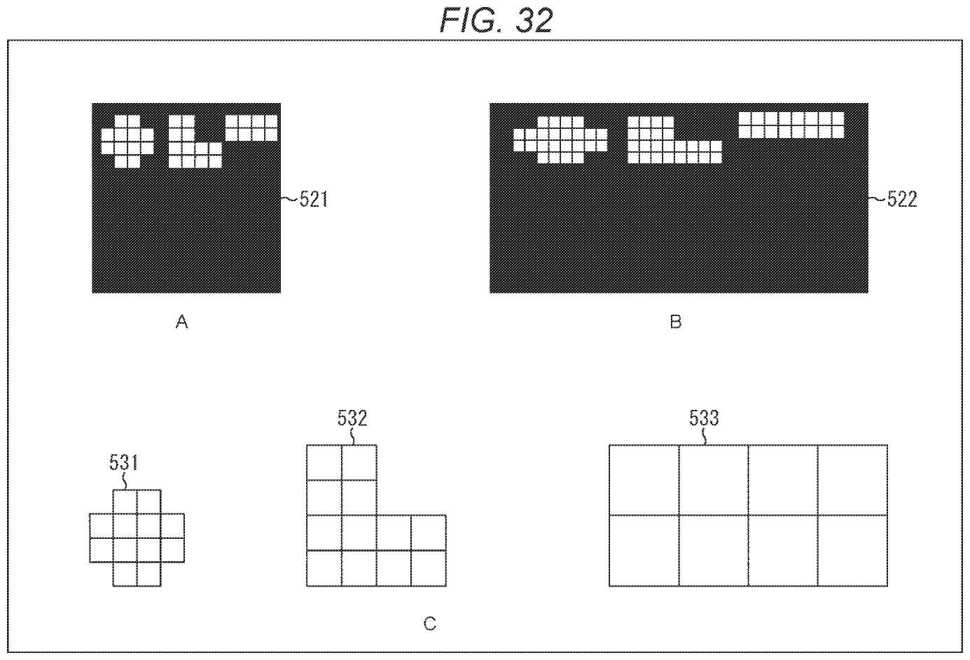

“2-4-2. Image size” is information indicating a size of an occupancy map, and is indicated by, for example, a width and a height of the occupancy map. That is, assuming that a height of an additional occupancy map 522 illustrated in B of FIG. 32 is 1 time and a width is 2 times with respect to a base occupancy map 521 illustrated in A of FIG. 32, width=2 and height=1 are specified. By doing in this way, it is possible to collectively control patches in the occupancy map. As a result, it is possible to suppress a reduction in encoding efficiency of auxiliary patch information.

“2-4-3. Ratio per patch” is information for specifying a ratio for every patch. For example, as illustrated in C of FIG. 32, information indicating a ratio of each of a patch 531, a patch 532, and a patch 533 can be transmitted. By doing in this way, a size of each patch can be more flexibly controlled. For example, accuracy of only required patches can be improved.

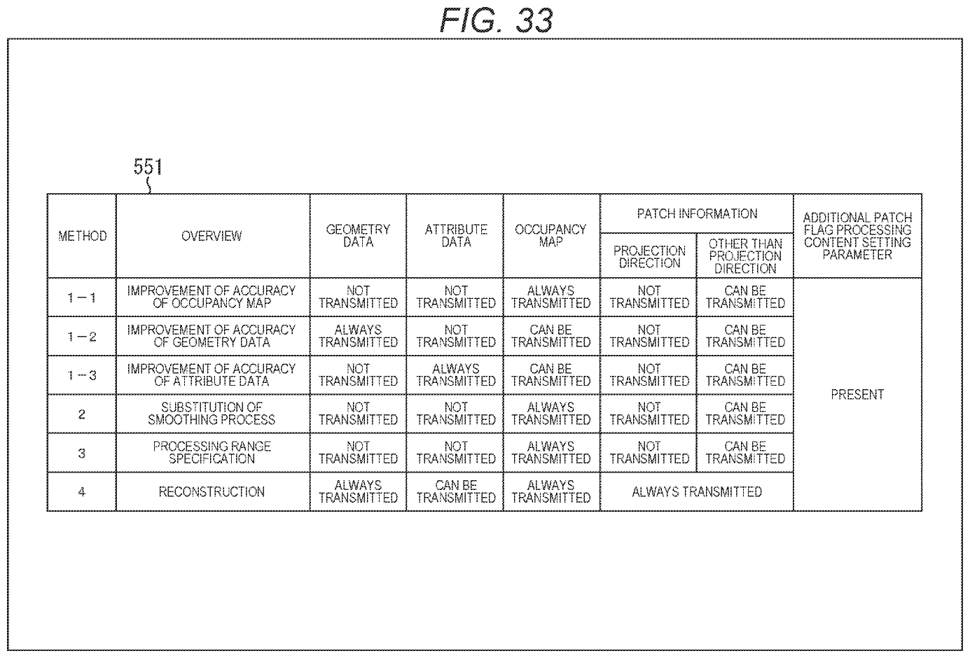

Note that an example of information transmitted in each of “Method 1” to “Method 4” described above is shown in Table 551 in FIG. 33. As shown in this Table 551, various types of information can be transmitted in each method.

As described above, by providing an additional patch for a base patch, local information accuracy can be controlled. As a result, it is possible to suppress deterioration of encoding efficiency, suppress an increase in load, and suppress deterioration of the reconstructed point cloud.

Furthermore, for example, an object can be reconstructed with accuracy corresponding to a distance from a viewpoint position. For example, by controlling whether or not to use the additional patch in accordance with a distance from a viewpoint position, an object far from the viewpoint position can be reconstructed with coarse accuracy of the base patch, and an object near the viewpoint position can be reconstructed with high accuracy of the additional patch.

Moreover, for example, it is possible to locally control quality of a point cloud reconstructed on the basis of authority of a user or the like (often locally control the subjective image quality of a display image). For example, it is possible to perform control such that the entire point cloud is provided with original quality (high resolution) to a user who has paid a high usage fee or a user having administrator authority, while the point cloud is provided with a part having a low quality (low resolution) (that is, provided in such a state in which a mosaic process is applied to a partial region in a two-dimensional image) to a user who has paid a low usage fee or a user who has guest authority. Therefore, various services can be implemented.

### 7. Supplementary Note

<Computer>

The series of processes described above can be executed by hardware or also executed by software. When the series of processes are performed by software, a program that configures the software is installed in a computer. Here, examples of the computer include, for example, a computer that is built in dedicated hardware, a general-purpose personal computer that can perform various functions by being installed with various programs, and the like.

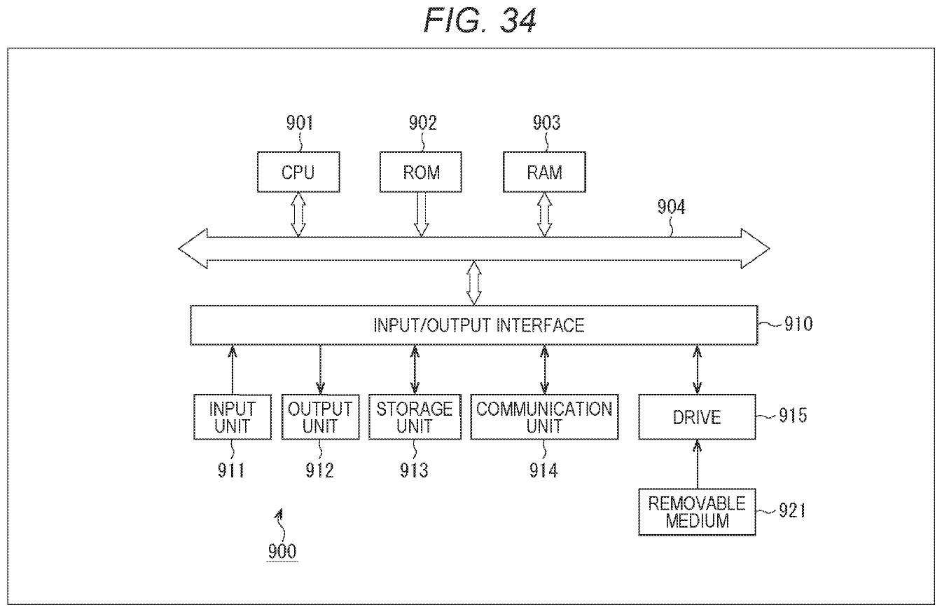

FIG. 34 is a block diagram illustrating a configuration example of hardware of a computer that executes the series of processes described above in accordance with a program.

In a computer 900 illustrated in FIG. 34, a central processing unit (CPU) 901, a read only memory (ROM) 902, and a random access memory (RAM) 903 are mutually connected via a bus 904.

The bus 904 is further connected with an input/output interface 910. To the input/output interface 910, an input unit 911, an output unit 912, a storage unit 913, a communication unit 914, and a drive 915 are connected.

The input unit 911 includes, for example, a keyboard, a mouse, a microphone, a touch panel, an input terminal, and the like. The output unit 912 includes, for example, a display, a speaker, an output terminal, and the like. The storage unit 913 includes, for example, a hard disk, a RAM disk, a nonvolatile memory, and the like. The communication unit 914 includes, for example, a network interface or the like. The drive 915 drives a removable medium 921 such as a magnetic disk, an optical disk, a magneto-optical disk, or a semiconductor memory.

In the computer configured as described above, the series of processes described above are performed, for example, by the CPU 901 loading a program recorded in the storage unit 913 into the RAM 903 via the input/output interface 910 and the bus 904, and executing. The RAM 903 also appropriately stores data necessary for the CPU 901 to execute various processes, for example.

The program executed by the computer can be applied by being recorded on, for example, the removable medium 921 as a package medium or the like. In this case, by attaching the removable medium 921 to the drive 915, the program can be installed in the storage unit 913 via the input/output interface 910.

Furthermore, this program can also be provided via a wired or wireless transmission medium such as a local area network, the Internet, or digital satellite broadcasting. In this case, the program can be received by the communication unit 914 and installed in the storage unit 913.

Besides, the program can be installed in advance in the ROM 902 and the storage unit 913.

<Applicable Target of Present Technology>

The case where the present technology is applied to encoding and decoding of point cloud data has been described above, but the present technology can be applied to encoding and decoding of 3D data of any standard without limiting to these examples. That is, as long as there is no contradiction with the present technology described above, any specifications may be adopted for various types of processing such as an encoding and decoding method and various types of data such as 3D data and metadata. Furthermore, as long as there is no contradiction with the present technology, some processes and specifications described above may be omitted.

Furthermore, in the above description, the encoding device 100, the decoding device 200, and the like have been described as application examples of the present technology, but the present technology can be applied to any configuration.

For example, the present technology may be applied to various electronic devices such as a transmitter or a receiver (for example, a television receiver or a mobile phone) in satellite broadcasting, cable broadcasting such as cable TV, distribution on the Internet, and distribution to a terminal by cellular communication, or a device (for example, a hard disk recorder or a camera) that records an image on a medium such as an optical disk, a magnetic disk, or a flash memory, or reproduces an image from these storage media.

Furthermore, for example, the present technology can also be implemented as a partial configuration of a device such as: a processor (for example, a video processor) as a system large scale integration (LSI) or the like; a module (for example, a video module) using a plurality of processors or the like; a unit (for example, a video unit) using a plurality of modules or the like; or a set (for example, a video set) in which other functions are further added to the unit.

Furthermore, for example, the present technology can also be applied to a network system including a plurality of devices. For example, the present technology may be implemented as cloud computing that performs processing in sharing and in cooperation by a plurality of devices via a network. For example, for any terminal such as a computer, an audio visual (AV) device, a portable information processing terminal, or an Internet of Things (IoT) device, the present technology may be implemented in a cloud service that provides a service related to an image (moving image).

Note that, in the present specification, the system means a set of a plurality of components (a device, a module (a part), and the like), and it does not matter whether or not all the components are in the same housing.

Therefore, a plurality of devices housed in separate housings and connected via a network, and a single device with a plurality of modules housed in one housing are both systems.

<Field and Application to which Present Technology is Applicable>

A system, a device, a processing unit, and the like to which the present technology is applied can be utilized in any field such as, for example, transportation, medical care, crime prevention, agriculture, livestock industry, mining industry, beauty care, factory, household electric appliance, weather, natural monitoring, and the like. Furthermore, any application thereof may be adopted.

<Others>

Note that, in the present specification, “flag” is information for identifying a plurality of states, and includes not only information to be used for identifying two states of true (1) or false (0), but also information that enables identification of three or more states. Therefore, a value that can be taken by the “flag” may be, for example, a binary value of I/O, or may be a ternary value or more. That is, the number of bits included in the “flag” can take any number, and may be 1 bit or a plurality of bits. Furthermore, for the identification information (including the flag), in addition to a form in which the identification information is included in a bitstream, a form is assumed in which difference information of the identification information with respect to a certain reference information is included in the bitstream. Therefore, in the present specification, the “flag” and the “identification information” include not only the information thereof but also the difference information with respect to the reference information.

Furthermore, various kinds of information (such as metadata) related to coded data (a bitstream) may be transmitted or recorded in any form as long as it is associated with the coded data. Here, the term “associating” means, when processing one data, allowing other data to be used (to be linked), for example. That is, the data associated with each other may be combined as one data or may be individual data. For example, information associated with coded data (an image) may be transmitted on a transmission line different from the coded data (the image). Furthermore, for example, information associated with the coded data (the image) may be recorded on a recording medium different from the coded data (the image) (or another recording region of the same recording medium). Note that this “association” may be for a part of the data, rather than the entire data. For example, an image and information corresponding to the image may be associated with each other in any unit such as a plurality of frames, one frame, or a part within a frame.

Note that, in the present specification, terms such as “synthesize”, “multiplex”, “add”, “integrate”, “include”, “store”, “put in”, “introduce”, “insert”, and the like mean, for example, to combine a plurality of objects into one, such as to combine coded data and metadata into one data, and mean one method of “associating” described above.

Furthermore, the embodiments of the present technology are not limited to the above-described embodiments, and various modifications can be made without departing from the scope of the present technology.

For example, a configuration described as one device (or processing unit) may be divided and configured as a plurality of devices (or processing units). On the contrary, a configuration described above as a plurality of devices (or processing units) may be collectively configured as one device (or processing unit). Furthermore, as a matter of course, a configuration other than the above may be added to a configuration of each device (or each process unit). Moreover, as long as a configuration and an operation of the entire system are substantially the same, a part of a configuration of one device (or processing unit) may be included in a configuration of another device (or another processing unit).

Furthermore, for example, the above-described program may be executed in any device. In that case, the device is only required to have a necessary function (a functional block or the like) such that necessary information can be obtained.

Furthermore, for example, each step of one flowchart may be executed by one device, or may be shared and executed by a plurality of devices. Moreover, when one step includes a plurality of processes, the plurality of processes may be executed by one device or may be shared and executed by a plurality of devices. In other words, a plurality of processes included in one step can be executed as a plurality of steps. On the contrary, a process described as a plurality of steps can be collectively executed as one step.

Furthermore, for example, in a program executed by the computer, process of steps describing the program may be executed in chronological order in the order described in the present specification, or may be executed in parallel or individually at a required timing such as when a call is made. That is, as long as no contradiction occurs, processing of each step may be executed in an order different from the order described above. Moreover, this process of steps describing program may be executed in parallel with processing of another program, or may be executed in combination with processing of another program.

Furthermore, for example, a plurality of techniques related to the present technology can be implemented independently as a single body as long as there is no contradiction. Of course, any of the plurality of present technologies can be used in combination. For example, a part or all of the present technology described in any embodiment can be implemented in combination with a part or all of the present technology described in another embodiment. Furthermore, a part or all of the present technology described above may be implemented in combination with another technology not described above.

Note that the present technology can also have the following configurations.

(1) An image processing apparatus including:

a video frame generation unit configured to generate a base video frame in which a base patch is arranged, the base patch being obtained by projecting, on a two-dimensional plane for each partial region, a point cloud representing an object having a three-dimensional shape as a set of points, and generate an additional video frame in which an additional patch is arranged, the additional patch being obtained by projecting, on the two-dimensional plane same as in a case of the base patch, a partial region including at least a part of the partial region corresponding to the base patch of the point cloud, with at least some of parameters made different from a case of the base patch; and

an encoding unit configured to encode the base video frame and the additional video frame generated by the video frame generation unit, to generate coded data.

(2) The image processing apparatus according to (1), in which

the additional patch includes information with higher accuracy than the base patch.

(3) The image processing apparatus according to (2), in which

the additional video frame is an occupancy map, and

the additional patch indicates a region to be added to a region indicated by the base patch or a region to be deleted from a region indicated by the base patch.

(4) The image processing apparatus according (3), in which

the additional patch indicates a smoothing process result of the base patch.

(5) The image processing apparatus according to (2), in which

the additional video frame is a geometry video frame or a color video frame, and

the additional patch includes a value to be added to a value of the base patch or a value to be replaced with a value of the base patch.

(6) The image processing apparatus according to (1), in which

the additional patch indicates a range to be subjected to a predetermined process, in a region indicated by the base patch.

(7) The image processing apparatus according to (6), in which

the additional patch indicates a range to be subjected to a smoothing process, in a region indicated by the base patch.

(8) An image processing method including:

generating a base video frame in which a base patch is arranged, the base patch being obtained by projecting, on a two-dimensional plane for each partial region, a point cloud representing an object having a three-dimensional shape as a set of points, and generating an additional video frame in which an additional patch is arranged, the additional patch being obtained by projecting, on the two-dimensional plane same as in a case of the base patch, a partial region including at least a part of the partial region corresponding to the base patch of the point cloud, with at least some of parameters made different from a case of the base patch; and

encoding the base video frame and the additional video frame that have been generated, to generate coded data.

(9) An image processing apparatus including:

a decoding unit configured to decode coded data, generate a base video frame in which a base patch is arranged, the base patch being obtained by projecting, on a two-dimensional plane for each partial region, a point cloud representing an object having a three-dimensional shape as a set of points, and generate an additional video frame in which an additional patch is arranged, the additional patch being obtained by projecting, on the two-dimensional plane same as in a case of the base patch, a partial region including at least a part of the partial region corresponding to the base patch of the point cloud, with at least some of parameters made different from a case of the base patch; and

a reconstruction unit configured to reconstruct the point cloud by using the base video frame and the additional video frame generated by the decoding unit.

(10) An image processing method including:

decoding coded data, generating a base video frame in which a base patch is arranged, the base patch being obtained by projecting, on a two-dimensional plane for each partial region, a point cloud representing an object having a three-dimensional shape as a set of points, and generating an additional video frame in which an additional patch is arranged, the additional patch being obtained by projecting, on the two-dimensional plane same as in a case of the base patch, a partial region including at least a part of the partial region corresponding to the base patch of the point cloud, with at least some of parameters made different from a case of the base patch; and

reconstructing the point cloud by using the base video frame and the additional video frame that have been generated.

(11) An image processing apparatus including:

an auxiliary patch information generation unit configured to generate auxiliary patch information that is information regarding a patch obtained by projecting a point cloud representing an object having a three-dimensional shape as a set of points on a two-dimensional plane for each partial region, the auxiliary patch information including an additional patch flag indicating whether an additional patch is not essential for reconstruction of a corresponding partial region of the point cloud; and

an auxiliary patch information encoding unit configured to encode the auxiliary patch information generated by the auxiliary patch information generation unit, to generate coded data.

(12) The image processing apparatus according to (11), further including:

an additional video frame generation unit configured to generate an additional video frame in which the additional patch corresponding to the auxiliary patch information generated by the auxiliary patch information generation unit is arranged; and

an additional video frame encoding unit configured to encode the additional video frame generated by the additional video frame generation unit.

(13) The image processing apparatus according to (12), in which

the additional video frame is an occupancy map and a geometry video frame.

(14) The image processing apparatus according to (11), in which

the auxiliary patch information further includes information indicating an action target of the additional patch.

(15) The image processing apparatus according to (11), in which

the auxiliary patch information further includes information indicating a processing content to be performed using the additional patch.

(16) The image processing apparatus according to (11), in which

the auxiliary patch information further includes information regarding alignment of the additional patch.

(17) The image processing apparatus according to (11), in which

the auxiliary patch information further includes information regarding size setting of the additional patch.

(18) An image processing method including:

generating auxiliary patch information that is information regarding a patch obtained by projecting a point cloud representing an object having a three-dimensional shape as a set of points on a two-dimensional plane for each partial region, the auxiliary patch information including an additional patch flag indicating whether an additional patch is not essential for reconstruction of a corresponding partial region of the point cloud;

encoding the generated auxiliary patch information, to generate coded data.

(19) An image processing apparatus including:

an auxiliary patch information decoding unit configured to decode coded data, and generate auxiliary patch information that is information regarding a patch obtained by projecting a point cloud representing an object having a three-dimensional shape as a set of points on a two-dimensional plane for each partial region; and

a reconstruction unit configured to reconstruct the point cloud by using the additional patch, on the basis of an additional patch flag that is included in the auxiliary patch information generated by the auxiliary patch information decoding unit and indicates whether an additional patch is not essential for reconstruction of a corresponding partial region of the point cloud.

(20) An image processing method including:

decoding coded data, and generating auxiliary patch information that is information regarding a patch obtained by projecting a point cloud representing an object having a three-dimensional shape as a set of points on a two-dimensional plane for each partial region; and

reconstructing the point cloud by using the additional patch, on the basis of an additional patch flag that is included in the generated auxiliary patch information and indicates whether an additional patch is not essential for reconstruction of a corresponding partial region of the point cloud.

### REFERENCE SIGNS LIST

100 Encoding device
101 Patch decomposition unit
102 Packing encoding unit
103 Multiplexer
121 Occupancy map generation unit
122 Geometry video frame generation unit
123 OMap encoding unit
124 Video encoding unit
125 Geometry video frame decoding unit
126 Geometry data reconstruction unit
127 Geometry smoothing process unit
128 Color video frame generation unit
129 Video encoding unit
130 Auxiliary patch information generation unit
131 Auxiliary patch information encoding unit
200 Decoding device
201 Demultiplexer
202 Auxiliary patch information decoding unit
203 OMap decoding unit
204 and 205 Video decoding unit
206 3D reconstruction unit
221 Occupancy map reconstruction unit
222 Geometry data reconstruction unit
223 Attribute data reconstruction unit
224 Geometry smoothing process unit
225 Recolor process unit
451 Base patch 3D reconstruction unit
452 Geometry smoothing process unit
453 Recolor process unit
454 Additional patch 3D reconstruction unit
455 Geometry smoothing process unit
456 Recolor process unit

1. An image processing apparatus comprising:
a video frame generation unit configured to generate a base video frame in which a base patch is arranged, the base patch being obtained by projecting, on a two-dimensional plane for each partial region, a point cloud representing an object having a three-dimensional shape as a set of points, and generate an additional video frame in which an additional patch is arranged, the additional patch being obtained by projecting, on the two-dimensional plane same as in a case of the base patch, a partial region including at least a part of the partial region corresponding to the base patch of the point cloud, with at least some of parameters made different from a case of the base patch; and
an encoding unit configured to encode the base video frame and the additional video frame generated by the video frame generation unit, to generate coded data.

2. The image processing apparatus according to claim 1, wherein
the additional patch includes information with higher accuracy than the base patch.

3. The image processing apparatus according to claim 2, wherein
the additional video frame is an occupancy map, and
the additional patch indicates a region to be added to a region indicated by the base patch or a region to be deleted from a region indicated by the base patch.

4. The image processing apparatus according to claim 3, wherein
the additional patch indicates a smoothing process result of the base patch.

5. The image processing apparatus according to claim 2, wherein
the additional video frame is a geometry video frame or a color video frame, and
the additional patch includes a value to be added to a value of the base patch or a value to be replaced with a value of the base patch.

6. The image processing apparatus according to claim 1, wherein
the additional patch indicates a range to be subjected to a predetermined process, in a region indicated by the base patch.

7. The image processing apparatus according to claim 6, wherein
the additional patch indicates a range to be subjected to a smoothing process, in a region indicated by the base patch.

8. An image processing method comprising:
generating a base video frame in which a base patch is arranged, the base patch being obtained by projecting, on a two-dimensional plane for each partial region, a point cloud representing an object having a three-dimensional shape as a set of points, and generating an additional video frame in which an additional patch is arranged, the additional patch being obtained by projecting, on the two-dimensional plane same as in a case of the base patch, a partial region including at least a part of the partial region corresponding to the base patch of the point cloud, with at least some of parameters made different from a case of the base patch; and
encoding the base video frame and the additional video frame that have been generated, to generate coded data.

9. An image processing apparatus comprising:
a decoding unit configured to decode coded data, generate a base video frame in which a base patch is arranged, the base patch being obtained by projecting, on a two-dimensional plane for each partial region, a point cloud representing an object having a three-dimensional shape as a set of points, and generate an additional video frame in which an additional patch is arranged, the additional patch being obtained by projecting, on the two-dimensional plane same as in a case of the base patch, a partial region including at least a part of the partial region corresponding to the base patch of the point cloud, with at least some of parameters made different from a case of the base patch; and
a reconstruction unit configured to reconstruct the point cloud by using the base video frame and the additional video frame generated by the decoding unit.

10. An image processing method comprising:
decoding coded data, generating a base video frame in which a base patch is arranged, the base patch being obtained by projecting, on a two-dimensional plane for each partial region, a point cloud representing an object having a three-dimensional shape as a set of points, and generating an additional video frame in which an additional patch is arranged, the additional patch being obtained by projecting, on the two-dimensional plane same as in a case of the base patch, a partial region including at least a part of the partial region corresponding to the base patch of the point cloud, with at least some of parameters made different from a case of the base patch; and
reconstructing the point cloud by using the base video frame and the additional video frame that have been generated.

11. An image processing apparatus comprising:
an auxiliary patch information generation unit configured to generate auxiliary patch information that is information regarding a patch obtained by projecting a point cloud representing an object having a three-dimensional shape as a set of points on a two-dimensional plane for each partial region, the auxiliary patch information including an additional patch flag indicating whether an additional patch is not essential for reconstruction of a corresponding partial region of the point cloud; and
an auxiliary patch information encoding unit configured to encode the auxiliary patch information generated by the auxiliary patch information generation unit, to generate coded data.

12. The image processing apparatus according to claim 11, further comprising:
an additional video frame generation unit configured to generate an additional video frame in which the additional patch corresponding to the auxiliary patch information generated by the auxiliary patch information generation unit is arranged; and
an additional video frame encoding unit configured to encode the additional video frame generated by the additional video frame generation unit.

13. The image processing apparatus according to claim 12, wherein
the additional video frame is an occupancy map and a geometry video frame.

14. The image processing apparatus according to claim 11, wherein
the auxiliary patch information further includes information indicating an action target of the additional patch.

15. The image processing apparatus according to claim 11, wherein
the auxiliary patch information further includes information indicating a processing content to be performed using the additional patch.

16. The image processing apparatus according to claim 11, wherein
the auxiliary patch information further includes information regarding alignment of the additional patch.

17. The image processing apparatus according to claim 11, wherein
the auxiliary patch information further includes information regarding size setting of the additional patch.

18. An image processing method comprising:
generating auxiliary patch information that is information regarding a patch obtained by projecting a point cloud representing an object having a three-dimensional shape as a set of points on a two-dimensional plane for each partial region, the auxiliary patch information including an additional patch flag indicating whether an additional patch is not essential for reconstruction of a corresponding partial region of the point cloud; and
encoding the generated auxiliary patch information, to generate coded data.

19. An image processing apparatus comprising:
an auxiliary patch information decoding unit configured to decode coded data, and generate auxiliary patch information that is information regarding a patch obtained by projecting a point cloud representing an object having a three-dimensional shape as a set of points on a two-dimensional plane for each partial region; and
a reconstruction unit configured to reconstruct the point cloud by using the additional patch, on a basis of an additional patch flag that is included in the auxiliary patch information generated by the auxiliary patch information decoding unit and indicates whether an additional patch is not essential for reconstruction of a corresponding partial region of the point cloud.

20. An image processing method comprising:
decoding coded data, and generating auxiliary patch information that is information regarding a patch obtained by projecting a point cloud representing an object having a three-dimensional shape as a set of points on a two-dimensional plane for each partial region; and
reconstructing the point cloud by using the additional patch, on a basis of an additional patch flag that is included in the generated auxiliary patch information and indicates whether an additional patch is not essential for reconstruction of a corresponding partial region of the point cloud.
